(19) United States
(12) Patent Application Publication
(10) Pub. No.: US 2009/0268664 A1
(43) Pub. Date: Oct. 29, 2009

(54) COMMUNICATION ROUTE OPTIMIZATION METHOD AND COMMUNICATION ROUTE OPTIMIZATION CONTROL DEVICE

(75) Inventors: Jun Hirano, Kanagawa (JP); Mohana Dhamayanthi Jeyatharan, Singapore (SG); Chan Wah Ng, Singapore (SG); Pek Yew Tan, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: Matsushita Electric Industrial Co., Ltd., Osaka (JP)

(21) Appl. No.: 12/094,104

(22) PCT Filed: Nov. 22, 2006
(86) PCT No.: PCT/JP2006/323868

§ 371 Date: May 16, 2008

(30) Foreign Application Priority Data
Nov. 22, 2005 (JP) 2005-337780
Jul. 7, 2006 (JP) 2006-188674

(51) Int. Cl. H04W 40/02

(52) U.S. Cl. 370/328

(57) ABSTRACT

The present invention provides a technique to optimize communication route when two end nodes separated away from own home perform data communication with each other. According to this technique, a communication node (the initiator node 174) adds a predetermined destination option including own home address to a header of a packet to be transmitted to a correspondent node (LFN 151) under control of MR 141. HA 121 of MR copies a predetermined destination option and inserts it into a tunnel packet header when this packet is tunneled to MR. When the packet is transferred to the communication node under control, MR checks, by using the server, whether the predetermined destination option is inserted into the tunnel packet header or not. If it is inserted into the packet, a route optimization processing is started with the transmitter of the packet including the predetermined destination option with home address.

### TECHNICAL FIELD

The present invention relates to a communication technique using Internet Protocol (IP). In particular, the invention relates to a technique relating to route optimization (RO) as defined in the Mobile IPv6.

### BACKGROUND ART

At present, a multiple of devices are performing communication with each other by using IP network. In order to provide mobility support to mobile devices, mobility support (MIPv6: Mobile IPv6) in IPv6 is now being developed by IETF (Internet Engineering Task Force). In the Mobile IP, each mobile node has a permanent home domain. In case the mobile node is connected to own home network, a primary global address known as home address (HoA) is assigned to the mobile node. On the other hand, when the mobile node is separated away from the home network, i.e. when it is connected to other foreign network, a temporary global address known as CoA (Care-of Address) is normally assigned to the mobile node. The basic concept of the mobility support is that, even when the mobile node is connected to other foreign network, it is possible to reach the mobile node by its own home address.

According to the Non-Patent Document 1 as given below, such concept is practically executed by introducing an entity known as a home agent (HA) into the home network. The mobile node registers the care-of address to the home agent by using a message known as BU (binding update). As a result, the home agent can generate binding between the home address of the mobile node and the care-of address. The home agent intercepts a message directed to the home address of the mobile node, and it has a function to transfer the packet to the care-of address of the mobile node by encapsulating the packet (i.e. by turning the packet to a payload of a new packet, and this is also known as packet tunneling).

On the other hand, the number of wireless (or radio) devices is increasing further, and it is anticipated that new technical class would soon appear in the mobility techniques. One of such techniques is network mobility (NEMO), which changes connection point to the entire network including the node. When the concept of the mobility support for each host is extended to mobility support for the network including the node, the solution for the moving network has its purpose in providing a mechanism, by which it is possible to reach the node within the mobile network by the primary global address even when the mobile network is connected to Internet via a connection point whatever it may be.

In IETF, a solution on the network mobility is currently proposed as described in the Non-Patent Document 2 given below. Here, when a mobile router transmits BU to the home agent, a network prefix used by the node in the mobile network is designated by a mobile router. This network prefix is designated by using a specific option known as network prefix option inserted in BU. As a result, the home agent prepares a routing table based on the prefix, and the home agent can transfer the packet, which is to be transmitted to a transmission destination with such prefix, to the care-of address of the mobile router.

By using the tunneling technique, mobility support for a mobile host and network mobility support are offered. However, this causes a problem, which is known as “sub-optimal”. This problem occurs because, when the mobile node and its correspondent node (CN) perform communication, the packet to be transmitted is not sent via a direct route from the mobile node to the correspondent node but it must be sent via the home agent. In case the mobile node is separated away from the home agent, the communication is turned to be inefficient due to sub-optimization, and the delay of the packet is enhanced.

Based on the conditions as described above, the Non-Patent Document 1 describes that the mobile node can transmit BU to the correspondent node. In case the correspondent node identifies the binding of the home address of the mobile node with the care-of address, the packet to be transmitted between them is directly transmitted to and received at the care-of address of the mobile node (without passing through the home agent). However, for this purpose, the Mobile IP must be understood well and supported by the correspondent node. Further, when the mobile node must perform communication with a multiple of correspondent nodes, the number of the binding updates required for such execution is extensively increased. In order to transmit BU to the correspondent node, the mobile node must carry out return routability (RR) processing to exchange two specific packets between the mobile node and the correspondent node prior to the transmission of BU message. The specific packets to be transmitted are: home test init (HoTI) message, care-of test init (CoTI) message, and home test (HoT) and care-of test (CoT) messages to be transmitted from the correspondent node as responses to the HoTI message and the CoTI message respectively.

To solve the above problems, an entity known as a foreign agent defined in the Mobile IPv4 is described in the Patent Document 1 and the Patent Document 2 as given below. These solution methods are based on the assumption that the correspondent node itself is mobile. As a result, the correspondent node is connected under the control of a foreign agent. In order to achieve route optimization, a tunnel is established between the foreign agent of the mobile node and the foreign agent of the correspondent node. However, these solution methods are specific to the Mobile IPv4. In the Mobile IPv6, there is no concept such as foreign agent, and the application of these solution methods to the Mobile IPv6 or to the network mobility is not clearly defined. Perhaps, it would be necessary to provide an entity, which functions as a foreign agent. Also, the solution methods disclosed in the Patent Document 3 and the Non-Patent Document 3 as given below are similar to the methods as describe above.

The Patent Document 3 as given below discloses a routing optimization proxy, which intercepts a HoTI message and a CoTI message transmitted from the mobile node to the correspondent node. The routing optimization proxy carries out the return routability processing as a proxy of the correspondent node.

Further, the Non-Patent Document 3 describes a correspondent router (CR). When the mobile node tries to carry out route optimization between it and the correspondent node, the mobile node first tries to find an adequate correspondent router, which handles (acts as a proxy of) the correspondent node in question. When the correspondent router is determined, the mobile node transmits a binding update to the correspondent router. Thereafter, the packet to be transmitted from the mobile node to the correspondent node is tunneled to the correspondent router. The correspondent router decapsulates the packet and transfers the packet to the correspondent node. Similarly, the packet to be transmitted from the correspondent node to the mobile node is also intercepted by the correspondent router, and the correspondent router tunnels the packet to the mobile node. According to the solution method described in the Non-Patent Document 3, it is tried to solve the problem relating to MR under nest condition by the execution of reflective BU at the position of top level mobile router (TLMR) by the correspondent router.

Also, in the Non-Patent Document 4 as given below, description is given on the problem of route optimization (RO) from MR to CR, the problem of RO from MR under nest condition to CR, and the problem of RO with MR when MR is present in the visited domain. In this case, the problem is solved by inserting a path control header (PCH) in hop-by-hop option of the packet.

According to the solution method described in the Non-Patent Document 4, after performing decapsulation, an address of the starting point of the tunnel is inserted to the packet as hop-by-hop option. Upon receipt of PCH hop-by-hop option including the address of the starting point of the tunnel, CR initiates a binding request to CoA of MR at the innermost side of PCH in case MR is under nest condition, for instance.

This method is different from the method described in the Non-Patent Document 3 in that explicit search of CR is not performed by MR and that the standard RR is not carried out between MR and CR. Also, according to this method, CR fixed in infrastructure and mobile CR (MR) are operated as CR and interpret the PCH option.

According to the Non-Patent Document 5, MR operates as a proxy of a local fixed node (LFN) connected under the control of MR, and signaling based on MIPv6 is performed between MR and CN in order to accomplish RO between CN and LFN. Here, if it is assumed that CN understands RO protocol based on MIPv6, MR transmits HoTI message and CoTI message to CN by using address of CN as a destination address and by using address of LFN or CoA of MR as a source address. This solution method aims to carry out perfect optimization between LFN present in the visited domain and CN positioned in the home domain.

Further, the patent Document 4 describes a method to optimize the communication between MNN and CN via at least the first upstream MR. This Patent Document 4 describes that it is difficult to verify PSBU by CN when MR selects the use of the standard BU and the BU (using PSBU) between MR and CN. Therefore, according to this method, binding from MR is carried out to CN for each MNN by a transmissive method without the recognition by MNN. In this connection, MR performs an extended RR for MR itself and for MNN connected, and BU is executed from MR to CN by using two different keys. MR generates a new key by three key generation tokens including a home key generation token of the standard RR, a care-of address key generation token, and an MNN key generation token, and MR uses this key for the registration of the address of MNN by BU to CN. The key generation tokens of the standard RR is used to generate the standard key in addition to the new key for registration of BU message as described above. Further, this method is extended to support MR under nest condition. As a result, all MRs under the nest condition perform BU to CN, and CN can estimate a tree path to MNN. Also, this indicates a method to accomplish RO to CN from each individual MNN.

In the Patent Document 5, route optimization between MR and CR is described. The technique disclosed in the Patent Document 5 is similar to the technique described in the Non-Patent Document 3, except that an official name server with higher reliability is used when the searching of CR is carried out. This server supports in determining the CR for the address of a specific CN requested from MR. Then, MR performs RR and BU to the determined CR. CR checks whether MR actually possesses this prefix or possesses an assembly of the prefixes prior to the setting of the tunnel. The technique disclosed in the Patent Document 5 needs public key infrastructure (PKI) for the operation of the system. Basically, a reliable key must be established between CR and the name server or between MR and the name server. Also, CR is regarded as a fixed node in the infrastructure of the system.

On the other hand, the importance of radio communication is increasing, and it is anticipated that many end nodes will be turned to mobile in future. For example, each MH moves, and LFN moves under the condition that it is always connected to the mobile network. In this case, it is required that the end node can be reached via the optimal route in case it is positioned in any domain/site/link of Internet.

Regarding two mobile nodes performing communication with each other while being present in the home link, or regarding two fixed nodes performing communication with each other while positioned at home link/home site/home domain, no specific problem occurs because packets are distributed via the optimized route by the standard IPv6 routing. However, when one or both of the end nodes are positioned in visited link/visited site/visited domain, it is necessary to have the condition (where reaching can be made) by the route optimization method, and the processing for this purpose must be carried out.

Also, when both end nodes are VMNs (visiting mobile node) and are in the first stage of nest or are mobile hosts (MH), bidirectional RR according to MIPv6 and bidirectional RO by BU/BA are achieved. When both of the two end nodes are in the first-stage nest condition, bidirectional RO is partially carried out. VMN in the first-stage nest condition is VMN connected under the control of MR when MR is present on the visited link directly connected to the Internet.

FIG. 1 shows the fallback in case the data is sent via a route, which is supported by the conventional standard protocol such as NEMO basic support. It is considered here that two peer nodes LFN 150 and LFN 151 in the visited domain try to perform communication with each other and that none of the peer nodes know the position of the other peer node or the peer nodes do not know that they are both moving with respect to the Internet topology (global communication network 100).

In this case, LFN 150 is connected to MR 140 via a link 103, and MR 140 is connected to an access router (AR) 130 via an access network 101. Similarly, LFN 151 is connected to MR 141 via a link 104, and MR 141 is connected to an AR 131 via an access network 102. Also, AR 130 and AR 131 are connected to a global communication network 100 (e.g. Internet). HA 120 is a home agent of MR 140, and HA 121 is a home agent of MR 141.

In case LFN 150 starts data communication session with LFN 151, LFN 150 sets destination address of datagram as HoA of LFN 151. Because LFN 150 is connected to MR 140 via a simple link 161, the packet is sent via MR 140.

MR 140 is provided with NEMO basic protocol. Thus, the packet is encapsulated and is tunneled via a route (bidirectional tunnel) 160. At HA 120, the packet is decapsulated. Because the destination is LFN 151, the packet is sent to the home domain of MR 141 via the route (extended link) 163. Here, HA 121 intercepts the packet and tunnels it to CoA of MR 141 via the route (bidirectional tunnel) 162. MR 141 intercepts and decapsulates the packet and transmits it to LFN 151. Also, similar processing is carried out in case LFN 151 transmits response to LFN 150.

In the scenario shown in FIG. 1, the data route is very long. Further, tunneling is performed at two instances on the route of the data packet, and average size of the packet is increased. Therefore, it is apparent that optimization is desirable.

FIG. 2 shows another scenario where the present invention is found to be useful. FIG. 2 shows the defects of the conventional protocol in the scenario as such. Here, also, description will be focused only on the standardized protocol.

Here, it is assumed that MH 170 is provided with MIPv6 RO protocol, and that LFN 151 can support RR by generating BCE (binding cache entry) and by transmitting HoT and CoT messages. Also, it is assumed that MR 141 is provided with NEMO basic support protocol. In this scenario, MH 170 and MR 141 are connected to the visited link. Also, according to this scenario, the peer node (MH 170) directly connected to AR 130 is trying to perform communication with LFN 151 connected to MR 141. Further, in this scenario, it is assumed that HA 120 is a home agent of MH 170, and HA 121 is a home agent of MR 141.

Because it is assumed that MH 170 is provided with MIPv6 RO module, MH 170 first starts RR processing to LFN 151. LFN 151 partially supports this RR processing, and CoA and HoA of MH 170 are registered in LFN 151. When MH 170 starts data communication, MH 170 uses its own CoA and avoids using the tunnel to HA 120. However, MH 170 does not grasp the position of the peer node (LFN 151), and the packet is sent to the home domain of LFN 151. HA 121 intercepts the packet and tunnels it to CoA of MR 141. Then, MR 141 performs decapsulation and transfers the packet to LFN 151.

When LFN 151 wants to transmit a response data packet, it checks its own BCE and discovers CoA of MH 170. Then, LFN 151 uses routing header type 2 (RH2) and performs source routing. Here, MR 141 refers to the destination address. Because the entry to support NEMO basic support unit or IPv6 routing table is not present in BCE, MR 141 tunnels the packet to its own HA 121. HA 121 decapsulates the packet and sends it to a correct gateway. Finally, the packet is sent to MH 170 by the standard IPv6 routing mechanism.

The problems seen in this case are that the route is distorted for a long stretch and there is a tunnel to increase the average size of the packet.

FIG. 3 shows a scenario where nest is present. In FIG. 3, the problem relating to the conventional standard protocol is shown. In FIG. 3, VMN 171 is in nest condition under the control of MR 140, and VMN 172 is in nest condition under the control of MR 141. Both of these VMN 171 and VMN 172 are trying to perform data communication with each other. Here, it is considered that both of VMN 171 and VMN 172 are provided with MIPv6 RO protocol. Also, it is considered that both of MR 140 and MR 141 are provided with NEMO basic support protocol. HA 120 is the HA of MR 140, and HA 121 is HA of MR 141. Also, MR 140 is connected to the global communication network 100 via AR 130, and MR 141 is connected to the global communication network 100 via AR 131.

First, it is assumed that VMN 171 and VMN 172 perform standard bidirectional RR, BU and BA and identify binding of HoA and CoA of each other by valid method. When data is transmitted after the first signaling, RH2 is used. MR 140 and MR 141 do not have destination address of the data packet to be transmitted from VMN 171 and VMN 172 in their binding cache or binding list (BL) and thus send the packets by tunneling to own HA 120 and HA 121 respectively. As a result, the data packet transmitted from VMN 171 is finally sent to VMN 172 via a simple link 165, a bidirectional tunnel 166, an extended link 167, another bidirectional tunnel 168, and a simple link 169.

Bidirectional RR, BU and BA increase the signaling cost of the protocol, and this means that a considerable amount of signaling occurs. Also, the packet passes through a route, which is partially optimized, and average size of the packet per route is increased due to the encapsulation by tunneling.

In order to understand the problem of the protocol relating to the prior art in another scenario, referring to FIG. 4, description will be given on a scenario, in which VMN 173 under nest condition is trying to perform communication with LFN 151, which is present in the visited domain. In FIG. 4, it is supposed that MR 140 and MR 141 are provided with NEMO basic protocol, and that the end host uses MIPv6 RO.

When unidirectional RR, BU and BA are carried out between VMN 173 and LFN 151, VMN 173 has no need to tunnel the data packet to its own HA 122. Instead of this, it can promptly use its own CoA. However, the entry relating to the address of LFN 151, which is a destination address, is not present in BCE, BL or the routing table of MR 140, and the data is tunneled to HA 120 of MR 140 via Route 10. The data is decapsulated at HA 120 and is sent to the home domain of MR 141. It is then sent to the home domain of MR 141 and is tunneled again to MR 141 via Route 11. Finally, the data packet is decapsulated at MR 141 and reaches LFN 151.

Similarly, when the response message is to be transmitted, LFN 151 directly sends it to CoA of VMN 173. At the entry of the route related table at MR 141, the destination address cannot be identified, and the packet is tunneled via HA 121 and it reaches the final destination VMN 173.

In this scenario, it is shown that the route of the data packet is distorted for a long stretch <I am not sure whether this means a long route> when MIPv6 RO protocol and NEMO basic support protocol are used.

Patent Document 1: Keiichi Shimizu and Yusuke Kinoshita, “Route Optimization Method and Agent Apparatus”, US Patent Application 20020009066A1, 29 May 2001.

Patent Document 2: Jarno Rajahalme, “Route Optimizing Mobile IP Providing Location Privacy”, WO 2004/010668, 19 Jul. 2002.

Patent Document 3: Cedric Westphal, “Routing Optimization Proxy in IP Networks”, US Patent Application 20040095913A1, 20 Nov. 2002.

Patent Document 4: Alexis Oliverau, Christophe Janneteau and Alexandru Petrescu “A Method of Validated Communication”, WO 2005/015853 A1, 17 Feb. 2005.

Patent Document 5: Marco Molteni, Pascal Thubert and Patrick Wetterwald “Arrangement for Retrieving Routing Information for Establishing a Bidirectional Tunnel between a Mobile Router and a Correspondent Router”, WO 2004/104740 A2, 2 Dec. 2004.

Non-Patent Document 1: Johnson, D. B., Perkins, C. E., and Arkko, J., “Mobility Support in IPv6”, Internet Engineering Task Force (IETF) Request For Comments (RFC) 3775, June 2004.

Non-Patent Document 2: Devarapalli, V., et. al., “NEMO Basic Support Protocol”, Internet Engineering Task Force (IETF) Request For Comments (RFC) 3963, January 2005.

Non-Patent Document 3: Ryuji Wakikawa and Masafumi Watari, “Optimized Route Cache Protocol”, IETF Internet Draft: draft-wakikawa-nemo-orc-00.txt, Work-In-Progress, July 2004.

Non-Patent Document 4: J. Na, S. Cho, C. Kim, S. Lee, H. Kang and C. Koo, “Route Optimization Scheme based on Path Control Header”, IETF Internet Draft: draft-na-nemo-path-control-header-00.txt, April 2004.

Non-Patent Document 5: C. Bernardos, M. Bagnulo, M. Calderon and I. Soto, “Mobile IPv6 Route Optimisation for Network Mobility (MIRON)”, IETF Internet Draft: draft-bernardos-nemo-miron-00.txt, Expires Jan. 12, 2006.

Non-Patent Document 6: C. Ng and J. Hirano, “Securing Nested Tunnels Optimization with Access Router Option”, IETF Internet Draft: draft-ng-nemo-access-router-option-01.txt, Expired Jan. 10, 2005.

However, in the solution method disclosed in the Patent Document 3 as given above, the correspondent node must change destination address, and it is not certain how it is operated in the specification of the current Mobile IPv6. Specifically, it is suggested here that the correspondent node still needs data structure necessary for binding cache entry (BCE), for instance, and must have functionality for route optimization. Also, when the correspondent node itself is mobile, it is not certain how it is operated in the solution method disclosed in the document.

The solution as disclosed in the Non-Patent Document 3 as given above provides the route optimization by simple procedure, but there are several points, which must be considered. First, the mobile node must find the correspondent router and this means that the load of the mobile node is increased. Secondly, the selection of optimal correspondent router is not guaranteed because the mobile node discovers the correspondent router by using the multi-cast address. Thirdly, there is a problem that no allusion is made on the verification as to how the mobile node judges that the selected correspondent router is not a malicious node but a really valid correspondent router. Fourthly, the correspondent router has a prefix common to the home address of the correspondent node, and if the correspondent node is not present on the home link, this solution method for optimization is not effective when the correspondent node is not present on the home link. This solution method is adequate for the correspondent node, which is positioned on home links.

According to the solution method disclosed in the Non-Patent Document 4, RO between MRs is performed by using PCH, but there are several problems. First, this protocol is an on-demand protocol, which is operated when necessary, while this option is detected by a multiple of CRs present on the route, and RO tunnel is generated with CoA included in the option. However, it is not that all nodes in CR domain necessarily needs the communication with the mobile network node (MNN) under the control of MR, and there is a problem that this processing may be useless. Secondly, there is a problem that a method with the same degree of security as RR and a method with similar security are not used in the binding from MR to CR. Thirdly, the transmission of address of the starting point of the tunnel by PCH is performed in the unit of the packet for each flow. As a result, this causes significant signaling cost. Fourthly, similarly to the case of the Non-Patent Document 3, MR uses prefix scoped binding update (PSBU) to CR, but CR cannot identify whether MR has really the prefix or not, and this means that a problem related to security may arise. Fifthly, all routers and nodes on the route check PCH hop-by-hop option, and this means increase in the processing cost and the delay due to processing.

Regarding the solution disclosed in the Non-Patent Document 5, there are some problems as described below. First, there is a problem in that MR must check all data packets to be transmitted from LFN and must change the source address to CoA of MR. Secondly, MR must intercept and check all data packets to LFN and must change the destination address to the home address of LFN and also must remove RH type 2 (routing header type 2) added at CN. Thirdly, in this solution, perfect route optimization can be carried out only when CN is present in the home domain. The fourth problem is that this RO is carried out only for LFN, and MR must discriminate LFN from VMN.

According to the technique disclosed in the Patent Document 4, no detailed scrutiny is made on the case where bidirectional RR is required when CN is not present in the home domain. In the technique disclosed in the Patent Document 4, there is a problem that CN must have complicated function to execute the extended RR.

Further, in the technique disclosed in the Patent Document 5, there is a problem that official name server cannot determine CR for CN when CN is present in the visited domain. Further, a large amount of signaling and manual setting must be made in advance so that the infrastructure with security can be set between the related correspondent routers and the official name server.

As described above, in FIG. 1 to FIG. 4, a basic problem relating to the route optimization is shown in case the peer nodes are present in the visited domain under low-level nest condition and in case the standard mobility related RO protocol or the mobility basic support protocol are used.

According to the prior art, many solutions have been proposed in case RO is carried out when one of the end nodes is positioned on the visited link/visited site/visited domain, and the other of the end nodes is in the home link/home site/home domain. However, there is no solution to solve the problem when secure bidirectional RO is tried to achieve in case both end nodes are positioned in visited link/visited site/visited domain, or in case one of the end nodes is a local fixed node (LFN) (it is assumed here that the local mobile node (LMN) fixedly connected under the control of MR is also included in LFN).

### DISCLOSURE OF THE INVENTION

To solve the above problems, it is an objective of the present invention to provide a communication route optimization method, by which it is possible to optimize the route of data communication when two end nodes separated away from own homes perform data communication with each other.

To attain the above objective, the communication route optimization method according to the present invention is a method for optimizing communication route to be performed between a first communication node and a second communication node under the control of a mobile router, wherein said method comprises the steps of:

inserting a predetermined destination option including information used for optimization of said communication route into a header of a packet to be transmitted to said second communication node;

receiving said packet transmitted to said second communication node from said first communication node by a home agent of said mobile router; and

encapsulating said packet in order to perform tunneling of said packet to said mobile router by the home agent of said mobile router, and inserting said predetermined destination option to the tunnel packet header by copying said predetermined destination option.

With the arrangement as described above, the mobile router can identify that the first communication, node is trying to optimize the route between itself and the second communication node, and it is possible to carry out route optimization processing between the first communication node and the mobile router.

Further, the present invention provides the communication route optimization method as described above, wherein said method further comprises the steps of:

detecting said packet where said predetermined destination option is present in said tunnel packet header by said mobile router;

transmitting a response message where information to perform route optimization between said first communication node and said mobile router is included by said mobile router to said first communication node;

performing route optimization between said first communication node and said mobile router; and

transmitting a packet to be transmitted between said first communication node and said mobile router so that the packet passes through the route optimized route as a result of said route optimization by said first communication node or said mobile router.

With the arrangement as described above, it is possible to optimize the route between the first communication node and the mobile router.

Also, the present invention provides the communication route optimization method as described above, wherein said first communication node is a mobile router different from said mobile router, and when a third communication node performing communication with said second communication node is detected, route optimization is performed between said mobile router for the purpose of optimizing the communication route between said second communication node and said third communication node.

With the arrangement as described above, the communication route between the second communication node and the third communication node can be optimized so that the data is not transferred to the home agent of the mobile router, which is present at upper level.

Further, the present invention provides the communication route optimization method as described above, wherein said first communication node uses a packet relating to a message to perform route optimization between said first communication node and said second communication node as said packet, to which said predetermined destination option is to be inserted.

With the arrangement as described above, it is possible to suppress the increase of the signaling message by using a message used in the conventional RR processing.

Further, the present invention provides the communication route optimization method as described above, wherein said method comprises a step of transmitting, by said mobile router to said first communication node, a response message including an information to perform route optimization between said first communication node and said mobile router to said message to perform route optimization between said second communication and said mobile router.

With the arrangement as described above, the mobile router can transmit the response message for performing optimization of the route between the first communication node and the mobile router when the message transmitted from the first communication node to the second communication node is intercepted.

Also, the present invention provides the communication route optimization method as described above, wherein said first communication node is a mobile node separated away from own home, and own home address is inserted into said predetermined destination option, and own care-of address is set to the source address of the packet where said predetermined destination option is inserted.

With the arrangement as described above, the mobile router can identify the address of the second communication node from the destination address of the packet and can identify the home address of the first communication node from a predetermined destination option.

Further, the present invention provides the communication route optimization method as described above, wherein said first communication node is a mobile node separated away from own home, a cryptographic key is inserted into said predetermined destination option, and own home address is set to a source address of the packet where said predetermined destination option is inserted.

With the arrangement as described above, the mobile router can identify the address of the second communication node from the destination address of the packet and can identify the home address of the first communication node from the source address of the packet and can acquire a cryptographic key from the predetermined destination option.

Also, the present invention provides the communication route optimization method as described above, wherein said method further comprises the steps of:

detecting the packet where said predetermined destination option is present in said tunnel packet header by said mobile router;

generating an information by said mobile router for verification by using said cryptographic key; and

transmitting a response message where an information for route optimization and said information for verification between said first communication node and said mobile router, by said mobile router to said first communication node.

With the arrangement as described above, route optimization processing with higher security can be accomplished by the transmission of a cryptographic key and an information for verification using a cryptographic key.

Further, the present invention provides the communication route optimization method as described above, wherein said method further comprises the steps of:

checking a predetermined destination option of a packet coming from outside of a mobile network under own control when said mobile router is connected to a home link; and

transmitting said response message by said mobile router when the prefix of the destination of said packet concurs with a prefix under control of said mobile router.

With the arrangement as described above, the route optimization between a first communication node and a second communication node can be carried out adequately even when a mobile router is present on a home link.

Also, the present invention provides the communication route optimization method as described above, wherein said method further comprises the steps of:

transmitting a response message to said first communication node when all mobile routers transferring said packet transfer said packet including said predetermined destination option; and

estimating, by the first communication node, a route to said second communication node based on said response message from each mobile router.

With the arrangement as described above, the first communication node can identify a mobile router present on a tree path to the second communication node.

Further, the present invention provides the communication route optimization method as described above, wherein said method further comprises the steps of:

inserting an information to indicate that said predetermined destination option can be copied once to a header of said packet by said first communication node;

encapsulating said packet to tunnel to any mobile router as desired by a home agent of said any mobile router, which first received said packet, inserting said predetermined destination to a tunnel packet header by copying said predetermined destination option, and inserting an information to indicate that copying of said predetermined destination option to said tunnel packet header is prohibited and

transmitting a response message where an information to perform route optimization between said first communication node and said mobile router is included, said message being transmitted to said first communication node by said mobile router to transfer said packet with said header where an information to indicate that said predetermined destination option can be copied once after decapsulation.

With the arrangement as described above, the first communication node receives a response message from an upstream mobile router existing at the position closest to any correspondent node as desired and can identify the presence of the upstream mobile router.

Further, to attain the above object, the present invention provides a communication route optimization control device to be packaged on a mobile node, wherein it is so arranged that own home address or a predetermined destination option including a cryptographic key is inserted to a header of a packet relating to a message to perform route optimization on a route between a correspondent node and said mobile node.

With the arrangement as described above, the mobile node can execute route optimization between itself and an upper level mobile router of the correspondent node even when the correspondent node is a communication node within the mobile network.

Also, the present invention provides a communication route optimization control device to be packaged on a mobile node, wherein communication between a communication node connected under own control and a correspondent node as desired is detected, and it is so arranged that a packet relating to a message to perform route optimization with said any correspondent as desired, and said packet being a packet where own home address or a predetermined destination option including a cryptographic key is inserted is transmitted to said correspondent node as desired.

With the arrangement as described above, the mobile router can carry out route optimization between itself and an upper level mobile router of the correspondent node for the purpose of optimizing the communication route between the communication node in the mobile network under control and the correspondent node even when the correspondent node is a communication node in the mobile network.

Further, the present invention provides a communication route optimization control device to be packaged on a home agent of a mobile router, wherein it is so arranged that, in case a predetermined destination option including information to be used for route optimization is inserted in a header of a packet to be tunneled to said mobile router, said packet is encapsulated to perform tunneling to said mobile router and said predetermined destination option is inserted into the tunnel packet header by copying said predetermined destination option to the tunnel packet header.

With the arrangement as described above, even when the packet is encapsulated, the predetermined destination option inserted by the first communication node is placed at the tunnel packet header, and the mobile router positioned at the exit of the tunnel can identify that the first communication node is going to perform the route optimization between itself and the second communication node.

Also, the present invention provides a communication route optimization control device to be packaged on a mobile router, wherein it is so arranged that, in case a predetermined destination option including information to be used for route optimization is inserted in a tunnel packet header of an encapsulated packet to be transferred to a communication node control, a response packet including own home address and the address of the communication node under control is transmitted.

By the arrangement as described above, the mobile router can carry out route optimization between itself and the transmitter of the packet when a packet with a predetermined destination option inserted in it is detected.

Further, the present invention provides a communication route optimization control device to be packaged on a mobile router, wherein said device checks a predetermined destination option included in a packet coming from outside of a mobile network under own control when the device is connected to a home link, and said device transmits said response message when the prefix of the destination address of said packet concurs with a prefix under control of said mobile router.

With the arrangement as described above, route optimization between the first communication node (being present outside of a mobile network) and the second communication node (being present inside of a mobile network) even when the mobile router is present on a home link.

Also, the present invention provides a communication route optimization control device to be packaged on a mobile node, wherein said device transmits a packet with a predetermined destination option inserted therein to any correspondent node as desired, and said device estimates a route to said second communication node by receiving a response message to said packet from a mobile router to pass through before the arrival of said packet at said any communication node as desired.

With the arrangement as described above, the mobile node can identify a mobile router present on a tree path to any correspondent node as desired.

Further, the present invention provides a communication route optimization control device to be packaged on a mobile router, wherein said device transmits a response message to a transmission source of said packet when said packet including a predetermined destination option is transferred.

With the arrangement as described above, the mobile node can identify a mobile router present on a tree path to any correspondent node as desired.

Also, the present invention provides a communication route optimization control device to be packaged on a mobile node, wherein said device transmits a packet to any correspondent node as desired by adding an information to a packet where a predetermined destination option is inserted, said information is to indicate that said predetermined destination option can be copied only once to an encapsulated header when said packet is encapsulated.

With the arrangement as described above, a mobile node receives a response message from an upstream mobile router existing at the position closest to any correspondent node as desired and can identify the presence of the upstream mobile router.

Further, the present invention provides a communication route optimization control device to be packaged on a mobile router, wherein said device copies said predetermined destination option to an encapsulated header at the encapsulation of said packet when a packet including an information to indicate that said predetermined destination option can be copied only once together with the predetermined destination option, and said device is designed to add an information to indicate that copying of said predetermined destination option of said encapsulated header is prohibited.

With the arrangement as described above, a predetermined destination option added to a packet by a mobile node is transmitted only to an upstream mobile router present at the position closest to any correspondent node as desired, and the presence of the upstream mobile router can be identified by receiving a response message from the upstream mobile router.

The present invention has the arrangement as described above, and it provides the effects that the route of data communication can be optimized when two end nodes separated away from home perform data communication.

### BRIEF DESCRIPTION OF THE DRAWINGS

FIG. 1 is a schematical drawing to show a network arrangement of a first example of scenario in the prior art;

FIG. 2 is a schematical drawing to show a second example of scenario according to the prior art;

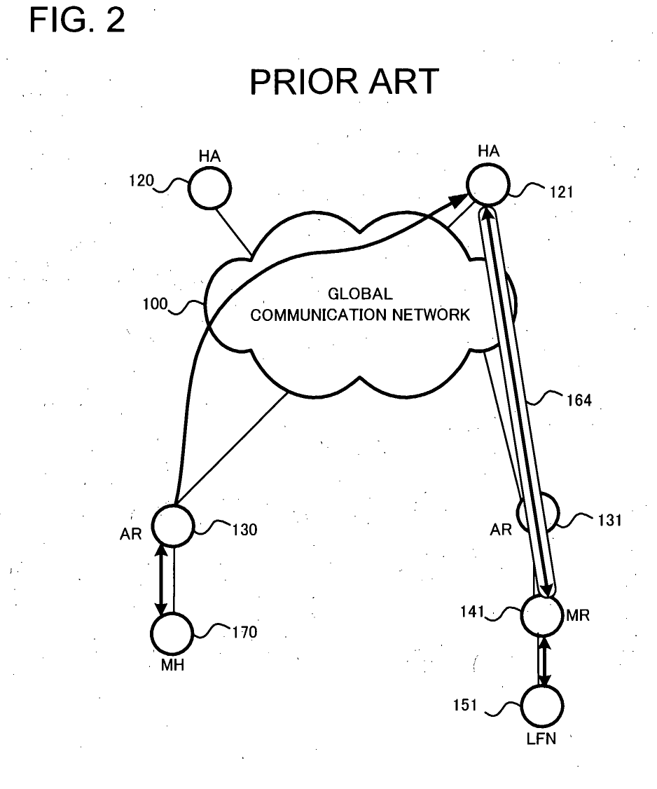

FIG. 3 is a schematical drawing to show a third example of scenario according to the prior art;

FIG. 4 is a schematical drawing to show a fourth example of scenario according to the prior art;

FIG. 5 is a block diagram to show an example of functional architecture of MH in an embodiment of the present invention;

FIG. 6 is a block diagram to show an example of functional architecture of MR in an embodiment of the present invention;

FIG. 7 is a schematical drawing to show a network arrangement of a first example of scenario in an embodiment of the present invention;

FIG. 8 is a sequence chart to show an example of message sequence in the scenario shown in FIG. 7;

FIG. 9 is a schematical drawing to show a network arrangement of a second example of the scenario in the embodiment of the present invention;

FIG. 10 is a schematical drawing to show a network arrangement of a third example of the scenario in the embodiment of the present invention;

FIG. 11 is a schematical drawing to show a network arrangement of a fourth example of the scenario in the embodiment of the present invention;

FIG. 12 is a sequence chart to show a first example of message sequence using a message relating to RR processing in the scenario shown in FIG. 10;

FIG. 13 is a sequence chart to show a second example of message sequence using a message relating to RR processing in the scenario shown in FIG. 10;

FIG. 14 is a schematical drawing to show a network arrangement of a fifth example of the scenario in the embodiment of the present invention;

FIG. 15 is a block diagram to show an example of structure of CoTI message used as a test message in the embodiment of the present invention;

FIG. 16 is a block diagram to show an example of structure of HoTI message used as a test message in the embodiment of the present invention;

FIG. 17 is a block diagram to show an example of structure of a response message in the embodiment of the present invention;

FIG. 18 is a schematical drawing to show a network arrangement of a sixth example of the scenario in the embodiment of the present invention;

FIG. 19 is a sequence chart to show an example of message sequence when MR is present in its home domain in another embodiment of the present invention;

FIG. 20 is a drawing to show an example of a scenario, in which both ends of uni-cast communication are present in the visited domain and one of them is in deep nest condition in another embodiment of the invention;

FIG. 21 is a sequence chart to show an example of message sequence according to a method not using ID or complicated status management algorithm in another embodiment of the invention;

FIG. 22 is a drawing to show an example of a structure of the packet of the test message after it is encapsulated by a first tunnel entry point when a method using ID according to another embodiment of invention is applied;

FIG. 23 is a drawing to show an example of a structure of the packet after it is tunneled at a first tunnel entry point when a mechanism not using ID according to another embodiment of the invention is applied;

FIG. 24 is a drawing to show an example of structure of a response message generated by the receiver of MCRDstOpt, which is an upstream MR of an ideal and desired MR set up to the destination of the test message in another embodiment of the present invention;

FIG. 25 is a drawing to show an example of a structure of a response packet to a first test packet from a desired receiver when a method using ID according to another embodiment of the invention is applied; and

FIG. 26 is a drawing of an arrangement of a network, schematically showing another example of a scenario according to the prior art.

### BEST MODE FOR CARRYING OUT THE INVENTION

Referring to the attached drawings, description will be given below on an embodiment of the present invention. In the embodiment of the invention described below, description will be given on the scenarios, which are regarded as showing the best aspects to disclose the present invention.

The present invention relates to a technique, which basically relates to bidirectional RO in case communication is performed between two end nodes present in visited link/site/domain. It is desirable that nest is not developed or nest is in one stage in case the end node is VMN. However, even in the case where high order nest is developed, the features such as identification of adequate CR and route optimization according to the present invention can be achieved.

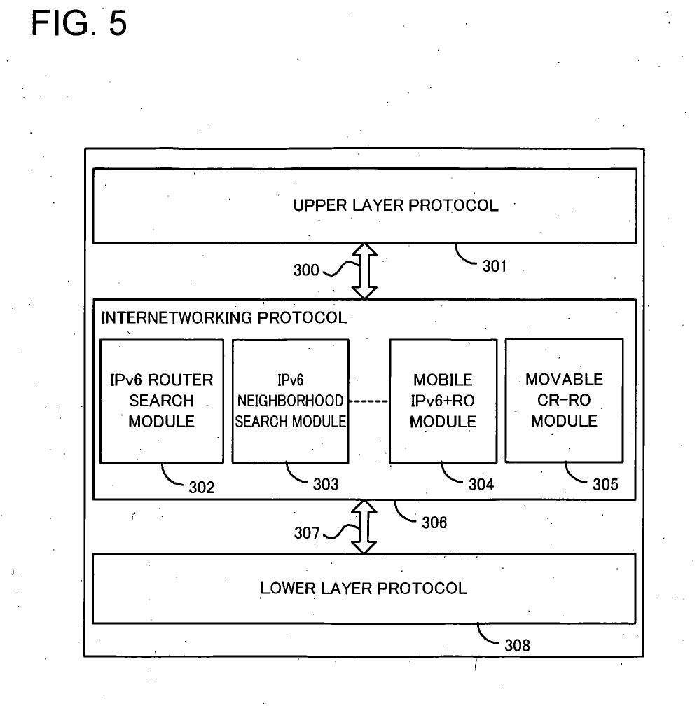

First, description will be given on functional architecture of MH to achieve the present invention referring to FIG. 5. In FIG. 5, a new routing unit module to actualize the protocol of layer 3 of the stack is shown. This new routing unit module is called here a movable CR-RO module 305. On the new RO protocol, detailed description will be given on another embodiment.

Here, it is supposed that the new RO unit is so designed that RO is offered when a peer node is present in visited domain. In this functional architecture, an upper layer protocol 301 comprises user application, session and transport protocol.

In an intermediate layer of the protocol, an Internetworking protocol 306 is present. The Internetworking protocol 306 comprises, for example, an IPv6 router search module 302 to execute IPv6 router search protocol, an IPv6 neighborhood search module 303 to execute IPv6 neighborhood search protocol, and several modules to execute the other protocols.

As the other protocols as described above, an address automatic arrangement protocol or a mobility support related protocol based on MIPv6 may be cited. FIG. 5 shows a Mobile IPv6+RO module 304 to execute mobility support protocol based on MIPv6 and RO and a movable CR-RO module 305 to execute a movable CR-RO protocol, i.e. a new RO protocol, as the modules to execute the mobility support related protocol based on IPv6. It is not that all functions of Internetworking layer are shown in FIG. 5. The functional architecture shown in FIG. 5 is for MH. In case there is no need to provide an ad hoc network, intra-domain routing protocol need not be supported in the stack.

Both the Mobile IPv6+RO module 304 and the movable CR-RO module 305, which are mobility related routing modules, have BCE and BL relating to themselves in order to support the functions of routing.

MH, which is present in home domain, performs communication by using the standard IPv6 mechanism when BCE using MIPv6 RO is not generated. Here, it is supposed that MH is present on the home link and its peer node is present in the visited domain. In this case, MH performs communication by using MIPv6 RO. Therefore, MH must operate all modules except the movable CR-RO module 305 in case it is present in the home.

On the other hand, in case MH is present in the visited domain, the registration to HA is indispensable. This is supported by the Mobile IPv6+RO module 304. Also, MH has a new RO unit (a movable CR-RO module 305). In case it is present in the visited domain, it always starts to use the protocol for RO. If a desirable response message supported by the mew RO protocol is not obtained, MH performs RO or uses MIPv6 RO in order to carry out tunneling via HA.

FIG. 5 shows a lower layer protocol 308. The lower layer protocol 308 has a data link layer related protocol and a physical layer protocol. Also, the data bus 300 indicates an interface between an upper layer protocol 301 and an Internetworking layer protocol 306. The data bus 307 indicates an interface between the lower layer protocol 308 and the Internetworking protocol 306.

This functional architecture is so arranged that the change of functional module in each layer is carried out independently without giving influence on the actualization of the other layer protocol of the stack or it is carried out within other functional entity, which is present in the stack with change.

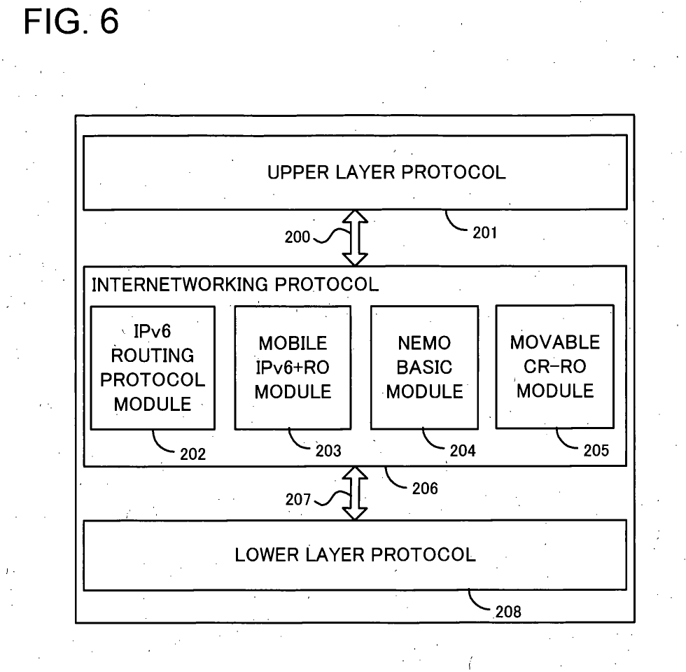

Further, FIG. 6 shows a preferred functional architecture of MR where the new movable CR-RO module is packaged. Because MR is a router, the routing unit of MR is more complicated than MH.

MR must support an IPv6 routing protocol module 202 to support intra-domain or IPv6 routing protocol, a Mobile IPv6+RO module 203, and a NEMO basic module 204 to execute NEMO basic support protocol. In addition to these, MR must actualize RO necessary for mobility non-matching LFN node connected under its own control and must support the movable CR-RO module 205 in order to attain further optimization for VMN connected to MR.

Similarly to normal functional architecture, the Internetworking layer protocol 206 to perform the processing relating to route management, routing, and routing related signaling is present between the upper layer protocol 201 and the lower layer protocol 208. Here, the main protocol function is to perform communication via an interface 200 and an interface 207.

In the arrangement as described above, the new RO module is started or RO processing is started only when either one of MH, VMN or MR is present in the visited domain. Also, the present invention is perfectly carried out when two peer nodes executing the data communication are present in the visited domain.

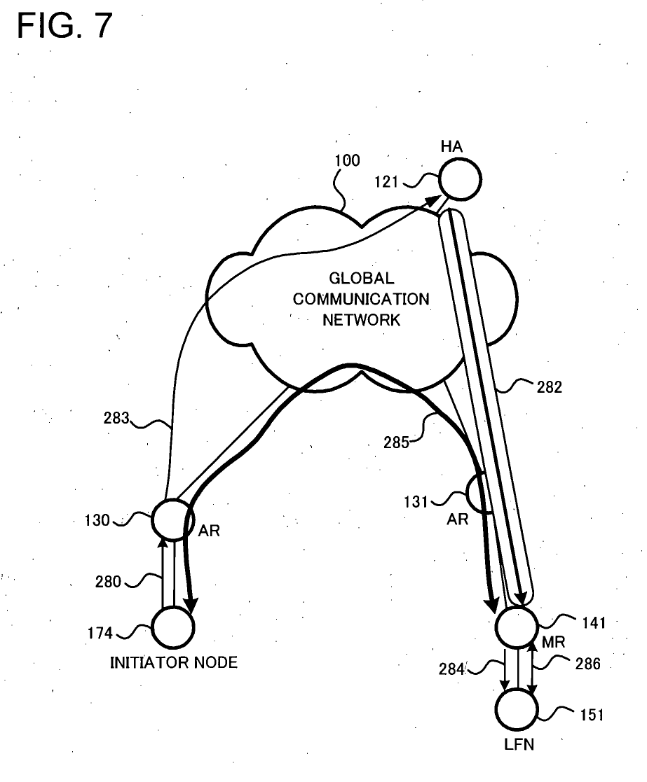

FIG. 7 shows a scenario, in which one of the peer nodes (here, it is referred as “an initiator node 174”) is present in the visited domain and starts RO processing and the other peer node (LFN 151) is present in another visited domain under the control of MR 141. In general, a scenario is conceivable, according to which the initiator node 174 attempts to start data communication with LFN 151 or to help RO for another node connected to the mobile network under it own control. Here, description will be given on the scenario, in which the initiator 174 attempts to perform data communication with LFN 151.

The initiator node 174 attempts to perform data communication with LFN 151 and transmits a test message to LFN 151 (Route 280). When the test message is prepared, MCRDstOpt (Movable CR Destination Option) is used in the destination extension header. In the example shown in FIG. 7, the initiator node 174 uses its own CoA as the source address. Also, the initiator node 174 transmits its own HoA at MCRDstOpt of a first test message. This test message is sent to the home domain of the destination node via Route 283 and is intercepted by HA 121, which is HA of MR 141.

HA 121 encapsulates the test message in tunnel. Further, it checks MCRDstOpt within the destination extension header and copies the MCRDstOpt to the tunnel header. According to the standard IPv6 tunneling specification, the tunnel entry point (e.g. HA 121) is requested to refer to the destination extension header prior to the encapsulation of the packet. After specifying MCRDstOpt, HA 121 copies MCRDstOpt to the destination extension header generated in the tunnel header. This tunnel message is transmitted via Route 282 and reaches MR 141.

MR 141 must perform operation to understand MCRDstOpt of the destination extension header. MR 141 operates as a supporting agent of LFN 151 and can provide support to RO. The first test message is delivered to LFN 151 via Route 284. LFN 151, which is a normal IPv6 node, abandons the option or the message relating to the execution of the present invention. It is desirable that the first bit of option type is so arranged that a receiver who cannot interpret this option neglects the option, and not the message.

Upon receipt of MCRDstOpt, MR 141 transmits its own home address and the address of LFN 151 by performing a response signaling as required to the initiator node 174. When the response is received, the initiator node 174 identifies that it is necessary to perform RO with MR 141 so that it is possible to reach LFN 151 by the optimized method. Further, the initiator node 174 identifies from the response that the peer node (LFN 151) is present in the visited domain. Therefore, after the response, the initiator node 174 and MR 141 perform bidirectional RR, BU and BA by using the method of MIPv6.

After the processing of tunneling has been completed between the initiator node 174 and MR 141, the initiator node 174 encapsulates the data in the tunnel to MR 141 if the data is to be transmitted to the tunnel to MR 141. In this case, it is desirable that an RH2 extension header is used in the tunnel header. The data packet from the initiator node 174 is tunneled to MR 141 via Route 285. MR 141 decapsulates the data and transmits the data to LFN 151 via Route 286.

In case LFN 151 is going to perform communication with the initiator node 174, LFN 151 sets the destination to HoA of the initiator node 174 because LFN 151 cannot execute RO (this is the most probable case) MR 141 checks BCE relating to the new routing module as given above and can specify HoA of the node, which is present there (the initiator node 174). Further, MR 141 also specifies that the address of LFN 151 is associated, with the entry in BCE. Therefore, MR 141 encapsulates the packet to the tunnel of RO (Route 285) by using CoA of the initiator node 174 as the destination address of the tunnel.

In this embodiment, description is given only on basic portion of the present invention and on a simple scenario. More complicated scenarios will be described in the other embodiments, and more detailed description will be given on the invention.

Also, it is assumed that LFN 151 does not support MIPv6 RO, while it can be present in this system even when LFN 151 supports MIPv6 RO. Description will be given below on a method to realize this.

When MCRDstOpt is transmitted—not as a test message as desired—but in RR stream started by the initiator node 174, LFN 151 (packaged with MIPv6 RO) can neglect MCRDstOpt. Then, LFN 151 executes RR and finally uses CoA of the initiator node 174 as the destination address of data transmission.

On the other hand, MR 141 can check whether CoA of the destination relating to the new protocol (the initiator node 174) is present in BCE or not. As a result, MR 141 does not start new RO processing by transmission of the message but performs tunneling via Route 285 instead. Therefore, unidirectional RR between the initiator node 174 and LFN 151 is basically turned to useless, and it is preferable to avoid this. This can be carried out by the initiator node 174 itself.

Specifically, when a response relating to the movable CR-RO is received from MR 141 and a response relating to the standard RR is received from LFN 151 (via MIPv6 RO), the initiator node 174 can differentiate two responses from each other and can suspend RR and BU further between itself and LFN 151. As a result, BCE is not formed in LFN 151. Or, as another method, if MR 141 can differentiate LFN 151 from VMN, MR 141 can notify LFN 151 so that it does not carry out RR.

The above problem depends on actual execution. Also, the scenario that LFN 151 is provided with MIPv6 RO does not occur very frequently. In fact, such scenario is very rare.

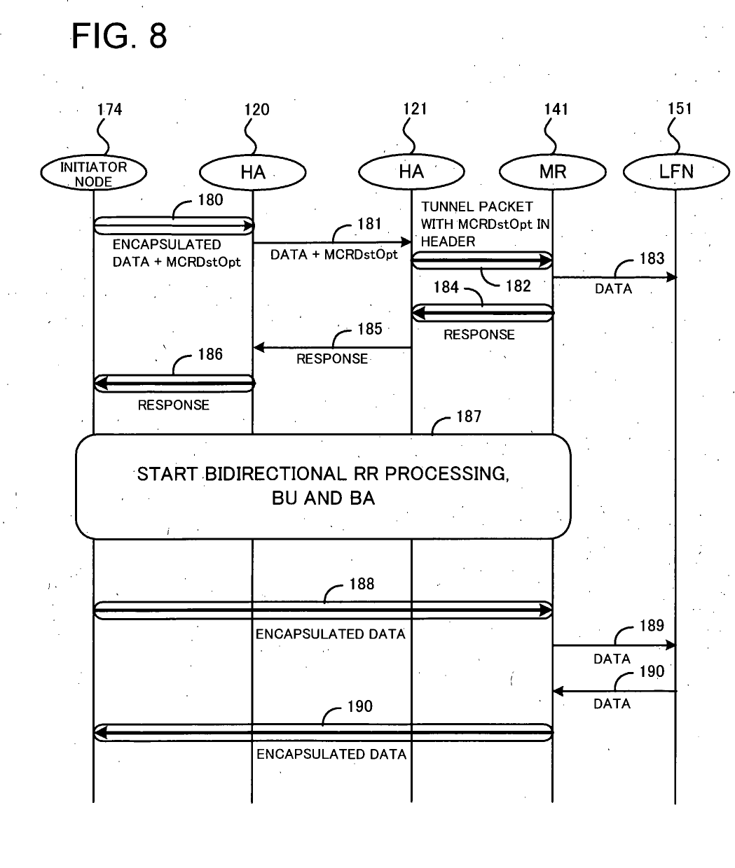

Next, in the embodiment given below, let us consider the case where LFN 151 is simply an IPv6 node. FIG. 8 shows the details on data route and signaling route when the present invention is carried out. HA of the initiator node 174 is HA 120, and HA of MR 141 is HA 121.

The initiator node 174 prepares a tunnel message with MCRDstOpt, which is encapsulated in the tunnel to its own HA 120. This tunnel message 180 is transmitted to HA 120. HA 120 decapsulates this tunnel message 180, and the decapsulated test message 181 is sent to the home domain of LFN 151.

HA 121 intercepts the original test message 181 and encapsulates the test message 181 to the tunnel packet 182 addressed to MR 141. Further, HA 121 copies MCRDstOpt of the test message 181 to the tunnel header. The tunnel packet 182 is decapsulated at MR 141. MR 141 stores the content of MCRDstOpt and the address of LFN 151 in its own memory. Also, the original test message 182 is delivered to LFN 151. LFN 151 is merely an IPv6 node and does not carry out the operation relating to the present invention as given above. That is, LFN 151 does not give response to the test message 183.

On the other hand, upon acquisition of MCRDstOpt, MR 141 uses HoA of its own as the source address and starts the response message, where only the address of LFN 151 is included as message parameter. In this connection, the initiator node 174 can check that HoA of MR 141 has the same prefix as the desired destination.

Then, MR 141 tunnels the response message 184 to its own HA 121. Upon receipt of the response message 184, HA 121 performs decapsulation and transmits the response message 185 to the home domain of the initiator node 174. After intercepting the response message 185, HA 120 encapsulates the response message and transmits the response message 186 to be tunneled to CoA of the initiator node 174. Upon receipt of the response message 186, the initiator node 174 performs decapsulation and acquires necessary parameters (HoA of MR 141 and address of LFN 151) from the response message 186. After intercepting the response message 186, the initiator node 174 and MR 141 execute bidirectional RR, BU and BA as shown in block 187 of FIG. 8.

After succeeding in the processing of the bidirectional binding, the initiator node 174 encapsulates the data to LFN 151 in the tunnel directed to CoA of MR 141 and transmits the tunnel packet 188. MR 141 decapsulates the tunnel packet 188 and transmits the data packet 189 to LFN 151. Similarly, when LFN 151 transmits the data packet 190 to the initiator node 174, it is encapsulated at MR 141 and is transmitted to CoA of the initiator node 174 by the tunnel packet 191 as shown in FIG. 8. In case the initiator node 174 is MH, the processing as shown in FIG. 7 and FIG. 8 is carried out.

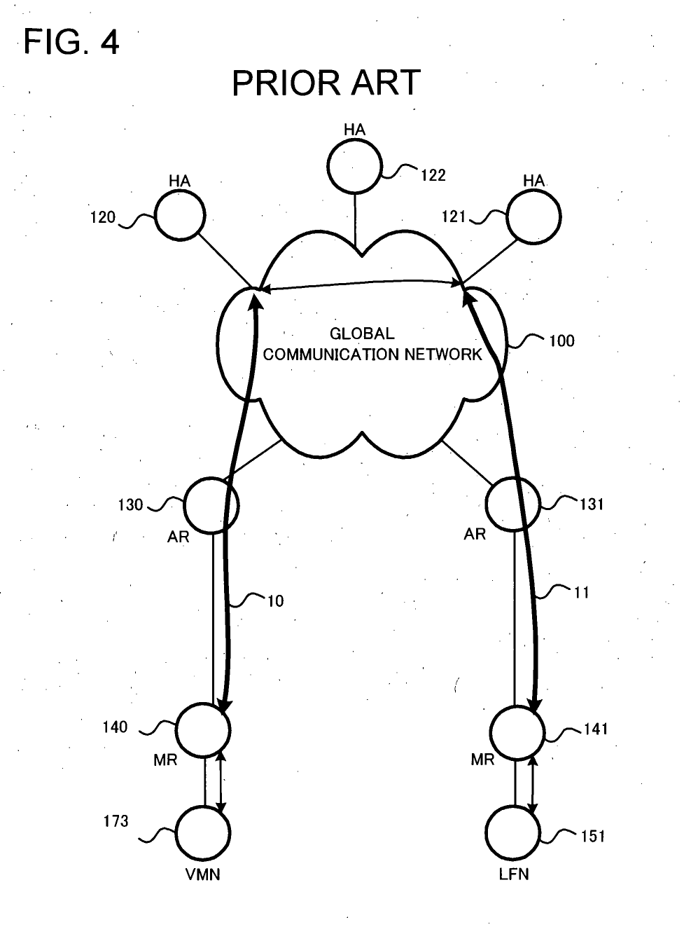

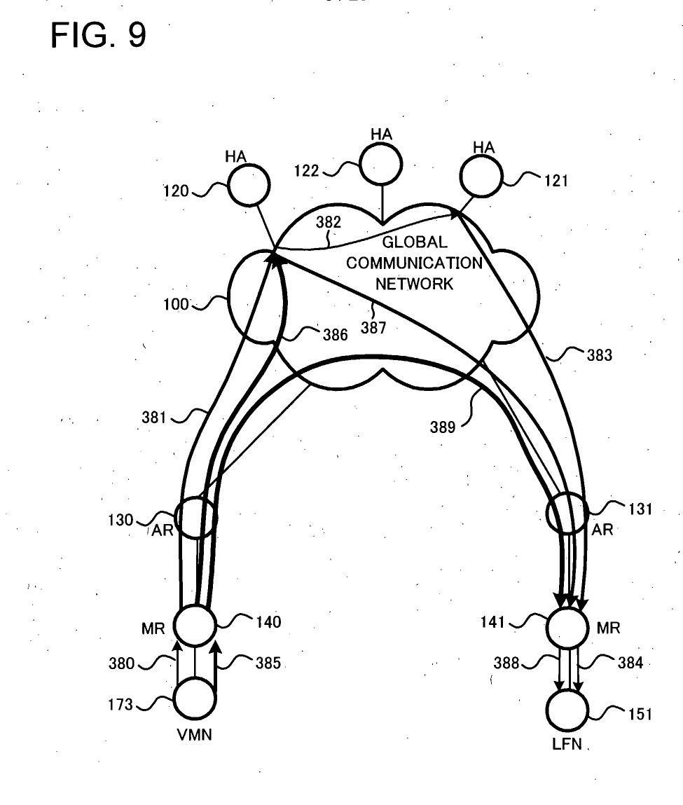

On the other hand, FIG. 9 shows a scenario in the embodiment of the present invention, according to which the routes of the routing is assuredly decreased in comparison with the scenario using the conventional protocol as shown in FIG. 4. In this embodiment, the description will be given on the present invention in case the initiator node 174 shown in FIG. 7 is VMN 173, and it is in nest condition under the control of MR 140, which is present in the visited domain.

FIG. 9 shows the scenario, in which VMN 173 is connected under the control of MR 140 and it is going to start the data communication with LFN 151 connected under the control of MR 141. Here, MR 141 is connected under the control of AR 131 via the visited link, and MR 140 is connected under the control of AR 130 via the visited link. In VMN 173, MR 140, and MR 141, the movable CR-RO module is packaged. HA 120 is HA of MR 140, and HA 121 is HA of MR 141. HA 122 is HA of VMN 173. HA 120, HA 121 and HA 122 must identify MCRDstOpt of the destination extension header and must perform the processing to copy MCRDstOpt to the tunnel header.

First, VMN 173 transmits a test message to LFN 151 (Route 380). This test message is encapsulated to the tunnel directed to HA 120 at MR 140 and is transmitted via Route 381. At HA 120, the test message is decapsulated and is sent to the home domain of LFN 151 via Route 382. Here, the test message is intercepted by HA 121. MCRDstOpt is copied to the tunnel header and is encapsulated and is sent via the tunnel of Route 383. This message reaches a tunnel exit point (MR 141).

MR 141 performs decapsulation in similar manner to the operation as described above and checks internal parameters. MR 141 transmits the response to VMN 173. Then, bidirectional tunnel is established between VMN 173 and MR 141 by the signaling relating to RR. The test message may be delivered to LFN 151 via Route 384, while LFN 151 does not understand this test message, and the test message is abandoned.

Here, VMN 173 identifies that the destination (correspondent) is LFN because it does have BCE of LFN 151. Therefore, VMN 173 tunnels the data packet to LFN 151 via the tunneling by MR 141. Specifically, at the tunnel header, the destination address is set to CoA of MR 141. The data packet tunneled from VMN 173 first reaches MR 140 via Route 385. Then, it is encapsulated further at MR 140 and is transmitted to HA 120 via Route 386. Here, the data packet is decapsulated and is transmitted to CoA of MR 141 via Route 387. MR 141 decapsulates the data packet, and the data packet reaches LFN 151 via Route 388.

MR 140 becomes aware that it does not have binding of CoA of MR 141, and normal test message processing (RR processing) is started. Finally, MR 140 and MR 141 have HoA and CoA respectively at the binding cache entry. When VMN 173 transmits the data packet to be tunneled to LFN 151 by RR processing, MR 140 performs tunneling to MR 141, and as a result, the packet is transmitted via Route 389, which is optimized further. There is also a better method to attain this purpose.

For example, in order to enable to pass an ingress filter and to reduce the overhead when attaining complete tunneling, it is desirable that MR 140 can be tunneled to MR 141 or that the source address can be changed to CoA of its own as the technique disclosed in the Non-Patent Document 6. MR 140 identifies that the address matches CoA of MR 141 by checking the destination address (CoA of MR 141) of the tunnel generated by VMN 173 (MR 140 has HoA and CoA of MR 141). MR 140 identifies that the source (VMN 173) of the tunnel is not LFN. As a result, the source address can be easily changed as in the technique disclosed in the Non-Patent Document 6.

When LFN 151 transmits the data packet to VMN 173 after RO as given above has been perfectly established, MR 141 checks BCE and searches the destination address (HoA of VMN 173) and source address of LFN 151 by using similar method and tunnels the packet to VMN 173. It is desirable that the destination of the tunnel header is CoA of MR 140 and that it has RH2 where entry of CoA and HoA of VMN 173 is included.

When FIG. 4 relating to the prior art is compared with FIG. 9, it is apparent that the optimized route is provided by the present invention.

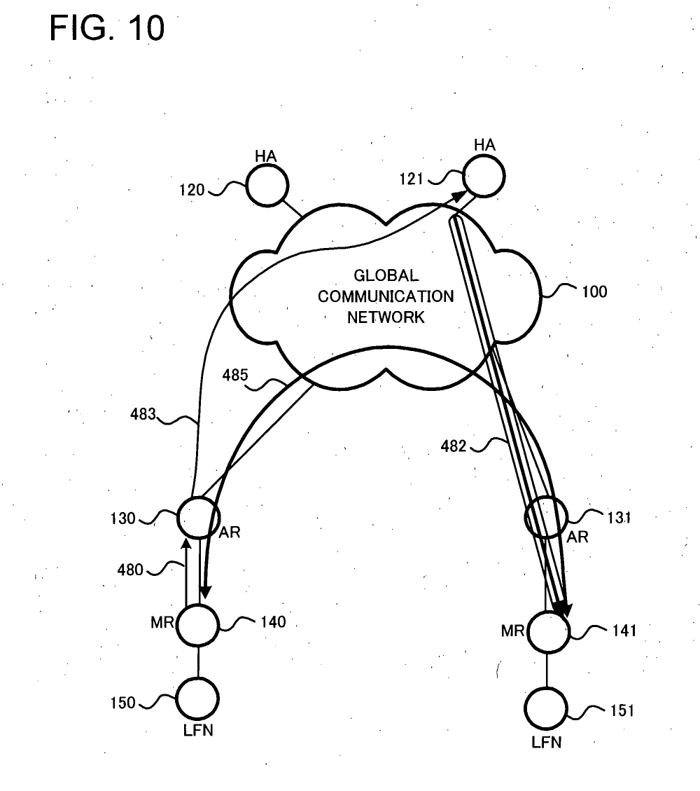

FIG. 10 shows a scenario, in which the initiator node 174 shown in FIG. 7 is MR. In this case, both LFN 150 and LFN 151 are present in the visited domain and are going to perform communication with each other. HA 120 is HA of MR 140, and HA 121 is HA of MR 141.

When LFN 150 initiates data communication, MR 140 starts the movable CR-RO module in order to optimize the route to LFN 151. As described in the above embodiment, the test message is transmitted via Routes 480, 483 and 482 and reaches MR 141. Here, it is supposed that CoA of MR 140 is used as the source address.

After intercepting the test message, MR 141 completes the response processing, and MR 140 and MR 141 establish bidirection tunnel. When LFN 150 transmits the data packet after tunnel has been established, MR 140 finds that the destination is LFN 151 and checks BCE, and it specifies the address of MR 140, which possesses the same prefix as that of LFN 151. Then, by encapsulating the packet to the above tunnel, MR 140 can transmit the packet via Route 485. Also, when LFN 151 transmits the data packet, similar processing is performed at the partner side (MR 141).

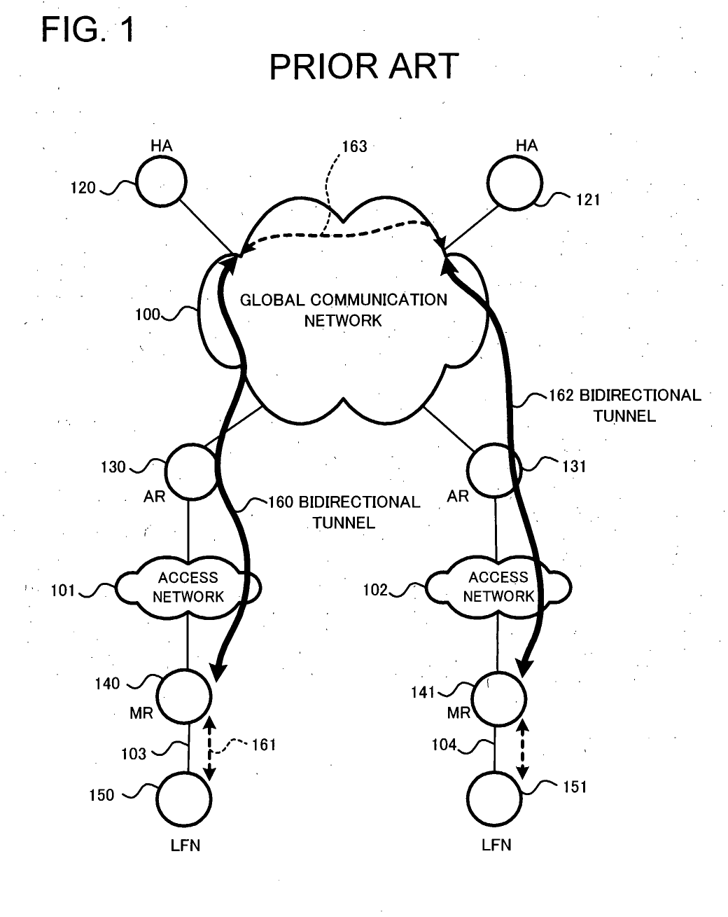

When FIG. 1 according to the prior art is compared with FIG. 10, the advantages of the present invention become apparent.

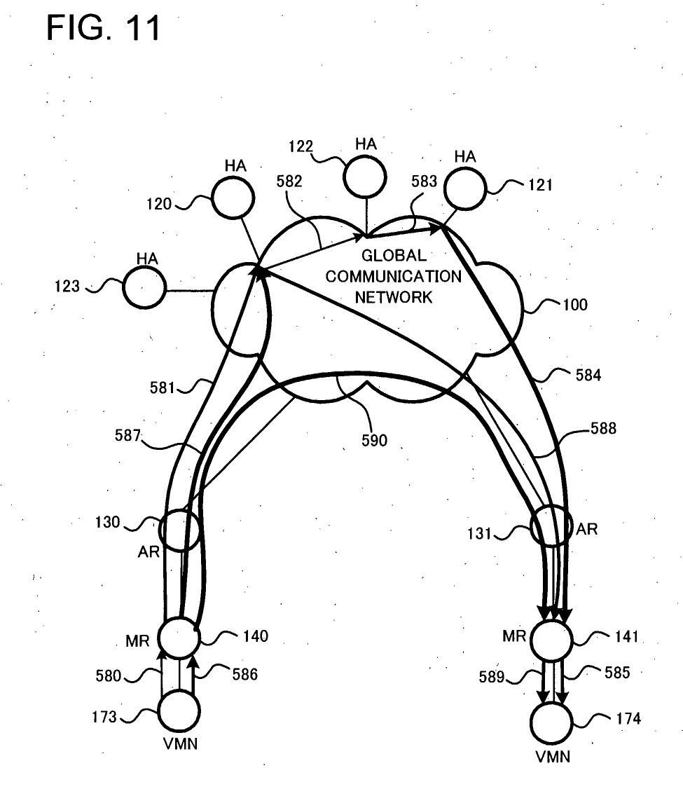

FIG. 11 shows a scenario, according to which VMN 173 and VMN 174 are both positioned in the visited domain, and these are in nest conditions under the control of MR 140 and MR 141 and perform data communication with each other. Further, MR 140 and MR 141 are also present in the visited domain. HA 120 is HA of MR 140, and HA 121 is HA of MR 141. HA 123 is HA of VMN 173, and HA 122 is HA of VMN 174.

In case VMN 173 is going to perform data communication with VMN 174, VMN 173 first arranges a test message, which has MCRDstOpt including its own HoA and has HoA of VMN 174 as the destination. In this scenario, in preparing the test message, CoA of VMN 173 is used as the source address.

This message is delivered to MR 140 via Route 580. Then, it is encapsulated at MR 140 and is transmitted via Route 581 and is decapsulated at HA 120. Next, this message is sent to the home domain of VMN 174 via Route 582. It is then intercepted by HA 122, and MCRDstOpt is copied to the tunnel header and is tunneled. The tunnel packet reaches HA 121 via Route 583. At HA 121, MCRDstOpt is copied again to the tunnel header and is further tunneled to CoA of MR 141.

When the message reaches MR 141 via Route 584, MR 141 acquires HoA of VMN 173 and becomes aware of the fact that the destination of the inner packet is CoA of VMN 174, which is present in the memory of its own. The test message reaches VMN 174 via Route 585. VMN 174 performs decapsulation and acquires MCRDstOpt (HoA of VMN 173). Both MR 141 and VMN 174 transmit the response to the test message to VMN 173 respectively.

Upon receipt of the response including HoA of these (MR 141 and VMN 174), VMN 173 initiates RR processing, BU and BA between these entities. After the processing of bidirectional RR, BU and BA, VMN 173 finally holds HoA and CoA of VMN 174 and further holds HoA and CoA of MR 141 within BCE related to the new routing module. Therefore, from this BCE, it can be found that VMN 173 must reach MR 141 in order to reach CoA of VMN 174 by the matching of prefix. When VMN 173 transmits the data to VMN 174, the destination is set to CoA of MR 141 and the final slot of RH2 is set to HoA of VMN 174.

When this packet reaches MR 140 via Route 586, the packet is tunneled to HA 120 of its own because MR 140 does not possess BCE including CoA of MR 141. As a result, the packet is transmitted via Route 587. HA 120 performs decapsulation of the packet, and the data packet inside it is transmitted via Route 588, and it finally reaches VMN 174 via Route 589. When VMN 174 immediately transmits the response data packet, VMN 174 uses CoA of VMN 173 as the destination because it does not know the other MR, which is present on the tree path to VMN 173 and prepares the data packet including only HoA of VMN 173 as the slot of RH2.

When acquiring this data packet, MR 141 becomes aware of the fact that the destination address is CoA of VMN 173 included in BCE. Therefore, MR 141 encapsulates the data packet to the tunnel to VMN 173 or transmits the message by changing the source address to CoA of its own. Finally, the message is sent via HA 120 of MR 140 and reaches VMN 173. Then, after the elapse of the time as desired, as explained in the above embodiment, MR 140 starts the movable CR-RO module and transmits the test message to MR 141 and finally establishes bidirectional tunnel with MR 141. Then, the data packet generated by VMN 173 is sent via Route 590. In this case, the packet is tunneled to MR 141 from MR 140. As a result, the route of the routing is shortened.

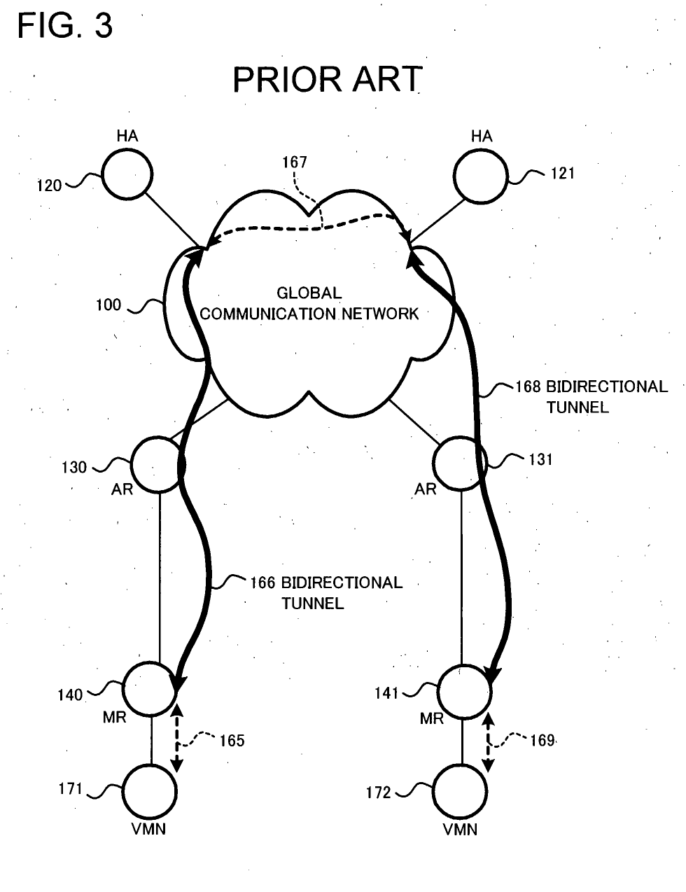

Similarly to the scenario as given above, this scenario shows operation of the present invention when the level of the nest is low. However, according to this embodiment, even when optimization is not aimed on the case of the nest condition, it is apparent that the present invention is carried out in case of nest condition. Compared with the cases of the prior art as shown in FIG. 3, it is apparent that the optimization of the route is perfectly achieved according to the present invention.

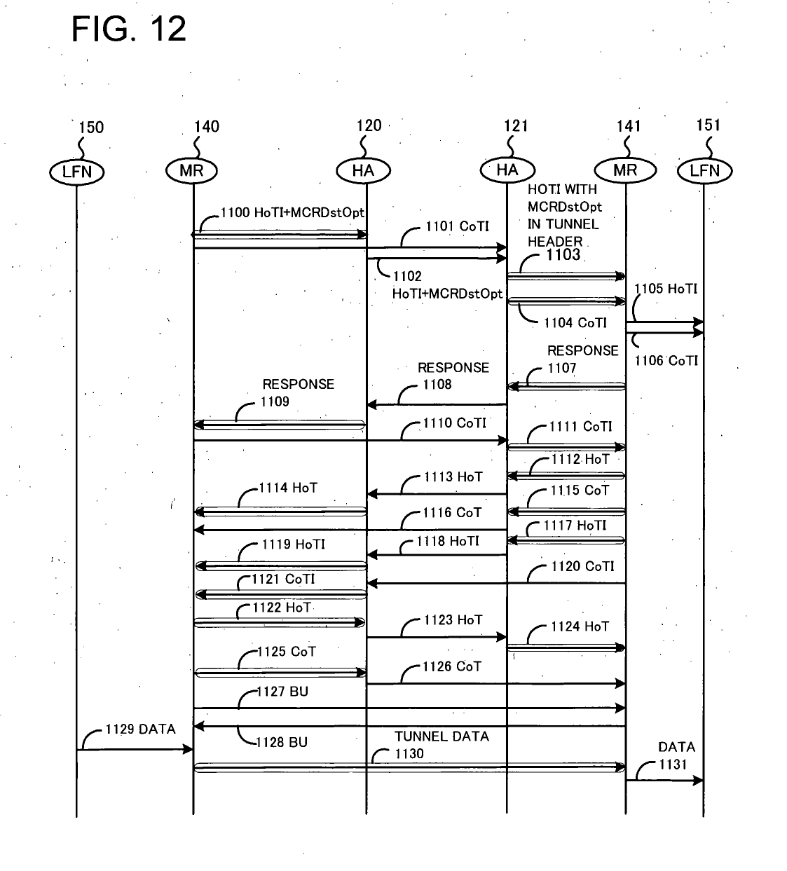

From FIG. 12, it is apparent that both LFN 150 and LFN 151 are present in the visited domain and the signaling in performing the data communication can be optimized. Description will be given below on this embodiment referring to FIG. 12. There are many methods to actualize the signaling as described here. In this embodiment, however, optimization is not performed and description will be given only on one of these methods.

Here, HoTI message generated when MR 140 starts the movable CR-RO module is used as the test message (therefore, there is no need to add the test message). The advantages to use HoTI message as the test message will be described in connection with the other embodiment.

In FIG. 12, HoTI message 1100 with MCRDstOpt is tunneled to HA 120 and is decapsulated at HA 120. The decapsulated HoTI message is sent to HA 121. At HA 121, the HoTI message is encapsulated, and the encapsulated HoTI message 1103 reaches MR 141.

MR 141 performs decapsulation and acquires necessary parameters (HoA of MR 140 and address of LFN 151) as explained in the above embodiment and also acquires home init cookie. Even in case the home init cookie is not addressed to MR 141, this processing is performed, and the signaling not needed for carrying out the invention is reduced. Finally, a HoTI message 1105 is transmitted to LFN 151 and it is abandoned at LFN 151. (However, it is assumed here that LFN 151 does not understand RO of any type.)

At the same time, MR 140 transmits a CoTI message 1101 addressed to LFN 151 by using CoA of its own as the source address. In the transmission of this CoTI message 1101, the end node (corresponded node) may be VMN or MH. In such case, it is possible to establish RO without delay. The CoTI message 1101 is generated at MR 140 and is sent to HA 121. Then, it is encapsulated at HA 121, and the encapsulated CoTI message 1104 is transmitted to MR 141. MR 141 simply decapsulates the CoTI message 1104 and transmits a CoTI message 1106 as a normal message to LFN 151. Because MCRDstOpt is not present in this CoTI message, MR 141 basically neglects the CoTI message 1106 and performs only the processing to transmit it to a correct destination (LFN 151).

Here, based on the above HoTI message, MR 141 arranges a response message. The response message can be embedded in a mobility header. MR 141 prepares a message containing HoA of its own as a source address in IPv6 header. MR 141 inserts the address of LFN 151 in mobility option of the mobility header and tunnels a response message 1107 to its own HA 121. At HA 121, the response message 1107 is decapsulated, and the decapsulated response message 1108 is sent to HA 120 of MR 140. At HA 120, the response message 1108 is encapsulated, and an encapsulated response message 1109 is tunneled to MR 140. The response message 1109 is transmitted to HoA of MR 140.

Upon receipt of the response message 1109, MR 140 determines to start bidirectional tunnel and transmits a CoTI message 1110 to MR 141. The home init cookie has been already transmitted, and consequently, there is no need to perform further transmission. It may be admitted that the operation in this embodiment has progressive character because optimization is carried out in order to suppress signaling storm. The CoTI message 1110 of MR 140 is transmitted to HoA of MR 141. As a result, the CoTI message 1110 is encapsulated at HA 121, and an encapsulated CoTI message 1111 is transmitted to MR 141. Upon receipt of the CoTI message 1111, MR 141 acquires a care-of init cookie from the CoTI message 1111. Then, similarly to the processing of MIPv6 RR, MR 141 generates a home key generation token and a care-of key generation token.

To those skilled in the art, it would be obvious that the home key generation token is prepared by using the home init cookie, HoA of the initiator node starting RR and nonce, and that the care-of key generation token is prepared by using the care-of init cookie, the care-of address of the initiator node starting RR and nonce.

After generating these tokens, MR 141 transmits a HoT message 1112 to HoA of MR 140. In the HoT message, the home key generation token, nonce index, and home init index are included. As the source address of the HoT message 1112, its own HoA is used. The encapsulated HoT message 1112 as given above is transmitted to HA 121. At HA 121, the HoT message 1112 is decapsulated, and a HoT message 1113 is sent to HA 120. At HA 120, the HoT message 1113 is encapsulated. As a result, a HoT message 1114 reaches MR 140. MR 140 decapsulates the HoT message 1114 and acquires the contents as required.

Similarly, MR 141 transmits a CoT message, which uses its own HoA as the source address. Here, MR 141 uses CoA of MR 140 as destination address. The CoT message containing the care-of init cookie, the care-of generation token, and the nonce index is encapsulated, and the encapsulated CoT message 1115 is tunneled to HA 121. HA 121 decapsulates the CoT message 1115 and sends a CoT message 1116 to CoA of MR 140. Upon receipt of the CoT message 1116, MR 140 starts the processing to calculate binding key, which is used to register BU at MR 141.

Almost at the same time as the receiving of the CoTI message 1111, MR 141 starts a HoTI, message to MR 140. This HoTI message is transmitted to HoA of MR 140. The source address is HoA of MR 141. As a result, the HoTI message 1117 is encapsulated, and it is transmitted to HA 121. At HA 121, the HoTI message 1117 is decapsulated, and a HoTI message 1118 is transmitted to HA 120. At HA 120, the HoTI message 1118 is encapsulated, and a HoTI message 1119 is transmitted to MR 140.

Almost at the same time, MR 141 transmits a CoTI message to MR 140. In this CoTI message, CoA of MR 141 is used as the source address, and HoA of MR 140 is used as the destination address. This CoTI message 1120 is transmitted to HA 120. It is then encapsulated at HA 120 and is tunneled to MR 140 as a CoTI message 1121.

Similarly, MR 140 can transmit a HoT message by using its own HoA as the source address and using HoA of MR 141 as the destination address. The HoT message 1122 is tunneled to HA 120 and is decapsulated at HA 120, and a HoT message 1123 is sent to HA 121. At HA 121, the HoT message 1123 is encapsulated, and an encapsulated HoT message 1124 reaches MR 141.

On the other hand, MR 140 transmits again a CoT message by using its own HoA as the source address and using CoA of MR 141 as the destination address. A CoT message 1125 is tunneled to HA 120. Then, a decapsulated CoT message 1126 reaches MR 141. MR 141 may also calculate a binding key necessary for itself.

MR 140 transmits its own BU message 1127 to MR 141. MR 140 uses its own CoA as the source address of the BU message 1127 and uses CoA of MR 141 as the destination address. Similarly, MR 141 also transmits a BU message 1128. Then, BU at MR 140 and MR 141 is completed. BA, which is a response to BU, is transmitted, but detailed description is not given here.

By the operation as described above, a data packet 1129 transmitted from LFN 150 is tunneled to MR 141 at MR 140, and a tunneled data packet 1130 reaches MR 141. Then, at MR 141, the tunneled data packet 1130 is decapsulated, and an original data packet 1131 reaches LFN 151.

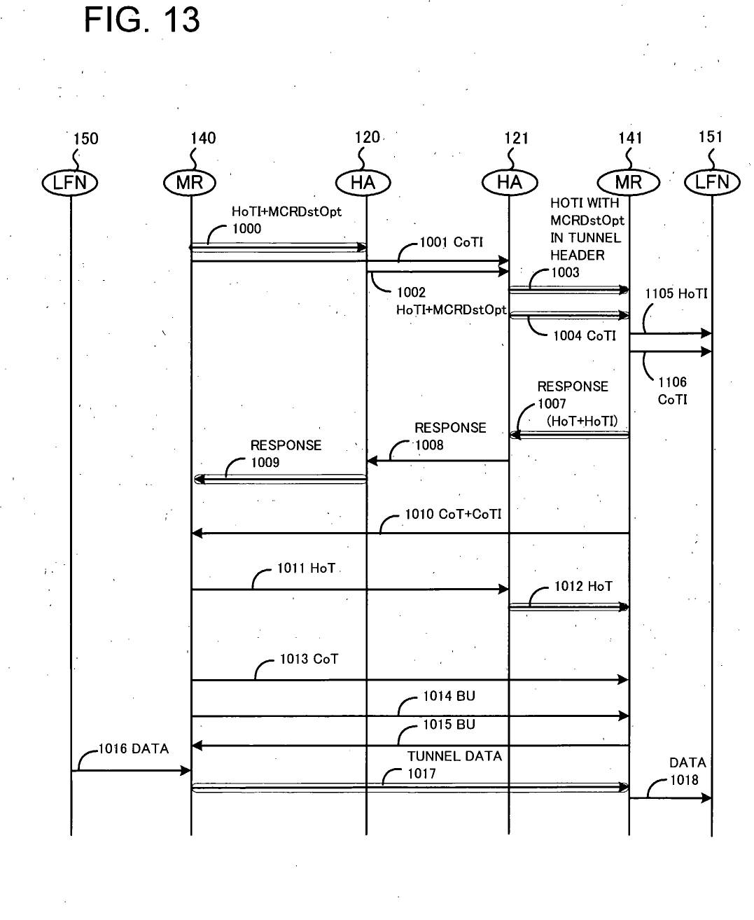

In case of VMN (and not LFN 151), in addition to the response generated by MR 141, the response by VMN itself is started. The parameters necessary for the response may be embedded in the CoT message transmitted by VMN. FIG. 13 shows that signaling stream can be optimized in the scenario shown in FIG. 12.

Although it is the same as in the scenario shown in FIG. 12, an embodiment of optimization possible in the signaling is given in FIG. 13. By comparing with FIG. 12, the advantages of the scenario of FIG. 13 to suppress signaling becomes apparent.

Also, in FIG. 13, MR 140 transmits a HoTI message 1000, and after the transfer of a HoTI message 1102 by HA 120, a HoTI message 1003 reaches MR 141. When decapsulating the HoTI message, MR 141 acquires home init cookie, MCRDstOpt, and address of LFN 151. In order to acquire the care-of init cookie from the CoTI message, MR 141 is turned to a state to search the CoTI message transmitted to the address of LFN 151. MR 141 detects a CoTI message 1004 and acquires the care-of init cookie from the CoTI message 1004.

Here, instead of transmitting individual response messages (independent HoT message to MR 140 and independent HoTI message to MR 140) to MR 140, all of these messages are combined together in a single response message 1007. HoA of MR 141 is used as the source address in the response message 1007, and the usefulness as the HoTI message is achieved. In the response message 1007, HoA of MR 140 is used as the destination address, and the usefulness as HoT message can be attained. Further, the address of LFN 151 is stored in this response message 1007. As a result, the usefulness as the response message can be attained.

In the response message 1007, in addition to the address of LFN 151, it is necessary that its own home init cookie, home key generation token generated by using the home init cookie transmitted from MR 140, nonce index, and the home init cookie transmitted from MR 140 are included. In case the response message 1007 is transmitted as a mobility header message, the above parameters may be inserted as a mobility option. This is determined depending upon actual execution.

As a result, the response message 1007 thus combined together is transmitted. Finally, the response message 1009 reaches MR 140. At MR 140, the message 1009 is decapsulated, and necessary parameters are acquired. From the received response message 1009, MR 140 identifies several parameters to prepare the home key generation token to transmit BU message and to prepare HoT message to be transmitted to MR 141. Further, because it is possible to reach LFN 151 via the tunnel to the source address of the response message, MR 140 identifies that the movable CR-RO module is usable. Here, description will be given simply on a scheme where optimization is performed by the combined message. After the response message 1009 has been transmitted, MR 141 transmits another combined message.

This message is a combined message of CoT message and CoTI message to be transmitted to MR 140 by MR 141. MR 141 sets the destination of the combined message to CoA of MR 140 identified from the CoTI message 1001. Based on the combined message, MR 141 indicates its own CoA to MR 140. Therefore, in the combined message, the effectiveness of the functions of CoTI message and CoT message is basically combined. By this combined message, the care-of init cookie generated by MR 141, the care-of key generation token generated by MR 141, the care-of init cookie used for generation of this token, and nonce index must be carried. The combined message as given above is the message 1010 shown in FIG. 13. This message 1010 may be prepared by using the mobility header in similar manner as described above. To those skilled in the art, it would be obvious that the type of the mobility headers differs according to different messages.

Upon receipt of the combined message 1010, MR 140 transmits a HoT message 1011 to MR 141. MR 140 must set the destination of the HoT message to HoA of MR 141. On the other hand, in order to perform optimization, MR 140 can also use its own CoA as the source address. This HoT message 1011 is transferred by HA 121 and reaches MR 141 as a HoT message 1012. Similarly, MR 140 transmits a CoT message 1013. Regarding the CoT message, it is important that the destination is set to CoA of MR 141.

Similarly to MIPv6 RR, the HoT message from MR 140 has normal parameters. Also, the same applies to the CoT message from MR 140. Finally, all optimization signalings relating to RR are completed, and MR 140 transmits a BU message 1014. Similarly, MR 141 transmits a BU message 1015. In FIG. 13, only BU stream is shown. Actually, however, BA is transmitted in association with each BU.

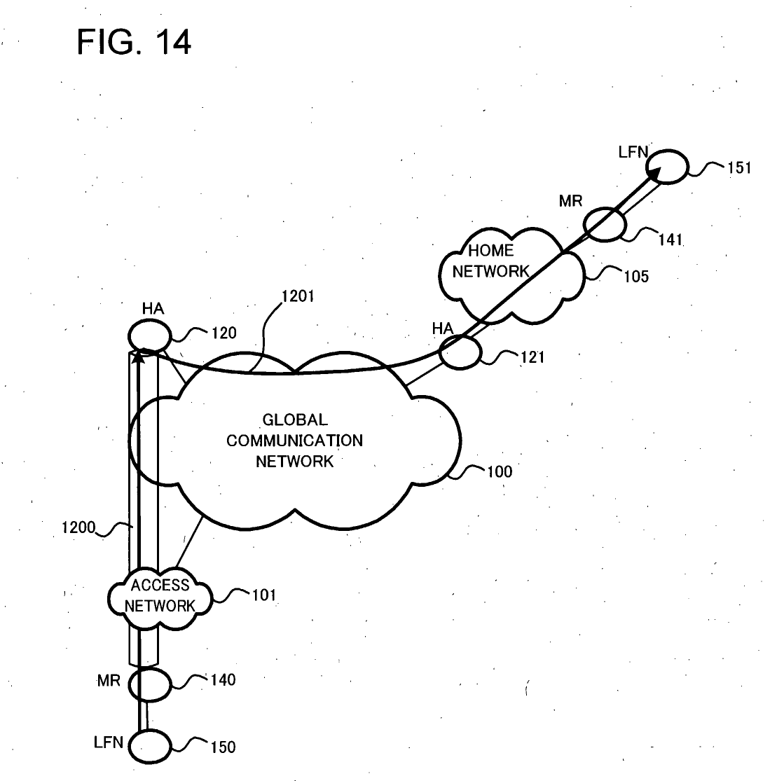

In FIG. 14, a scenario, in which the present invention does not completely succeed is shown. As described above, the present invention is optimized in case the peer node is primarily present in the visited domain (ideal scenario). In the following, however, different from the ideal scenario, description will be given on a case where RO according to the present invention is not performed (a scenario where the present invention does not succeed to full extent). In this case, also, the peer nodes are LFN 150 and LFN 151. Also, HA of MR 140 is HA 120, and HA of MR 141 is HA 121. Further, it is supposed here that MR 140 is present in the visited domain, and that LFN 151 is present in the home domain.

In case LFN 150 starts data communication with LFN 151, the processing of the test message is started as explained in the above embodiment because MR 140 is present on the visited link. This test message is sent via Route 1200 by tunneling. HA 120 performs decapsulation of the test message and sends the test message via Route 1201 to the home domain of LFN 151. Because HA 121 does not have binding, it cannot function as proxy and the test message is not intercepted. As a result, HA 121 does not carry out the tunneling to MR 141. Therefore, the message having MCRDstOpt reaches LFN 151, and not MR 141.

However, MR 141 is mobile, and it is separated away from the home domain in almost all cases. Therefore, attention is focused here on a scenario, according to which the condition where MR 141 is present in the home domain is not seen very often and MR 141 is not present in the home domain in the present invention. In case MR 141 is present in the home domain, if compared with the case shown in FIG. 1, optimization is performed partially on one-half of the route. Therefore, there is no substantial problem even in case where optimization may not be performed.

In the above, description has been given that there are many methods to transmit MCRDstOpt in the above operation. However, each of these methods have its advantages and problems.

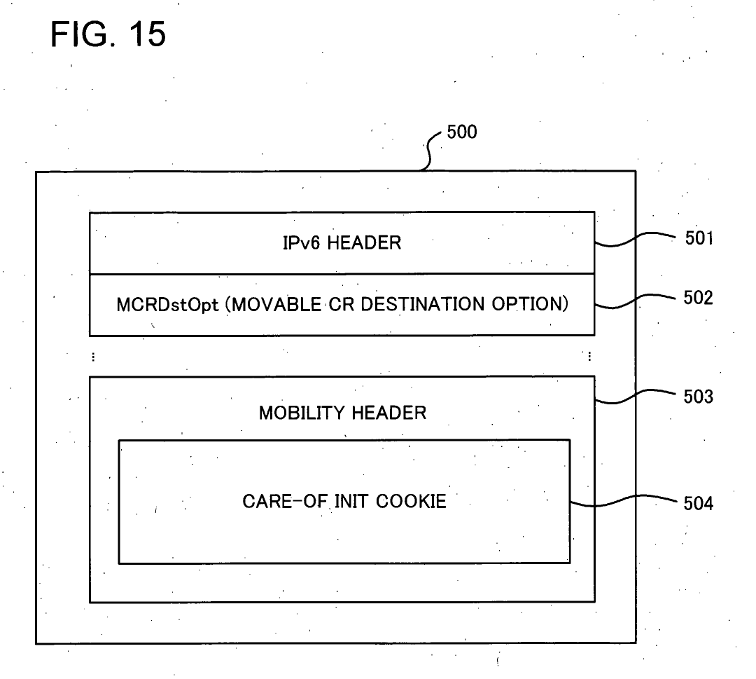

When a test message as desired is used, additional RR signaling to consume the band width must be performed in any of the cases, and there is possibility to cause delay in establishing the optimization route. Consequently, in the preferable method according to the present invention, a CoTI message is used as the test message. In FIG. 15, it is shown that a CoTI message can be used as the test message.

FIG. 15 shows an example of message structure of a CoTI message 500 used as the test message. This is a CoTI message, and source address of the IPv6 header 501 is CoA of the initiator node to transmit the message. Also, the destination is a receiver, who desires that the initiator node establishes the tunnel.

Further, MCRDstOpt (movable CR destination option) 502 to be inserted in the destination extension header is shown. In the CoTI message, HoA of the initiator node of the test message is not indicated, and HoA of the initiator node is inserted in MCRDstOpt. Also, similarly to the normal case, the CoTI message must transmit a care-of init cookie 504. This is added to data section of the mobility header 503.

The advantage of the use of CoTI message as the test message is that the CoTI message can reach the destination more quickly without being tunneled because CoA is used as the source address of the CoTI message.

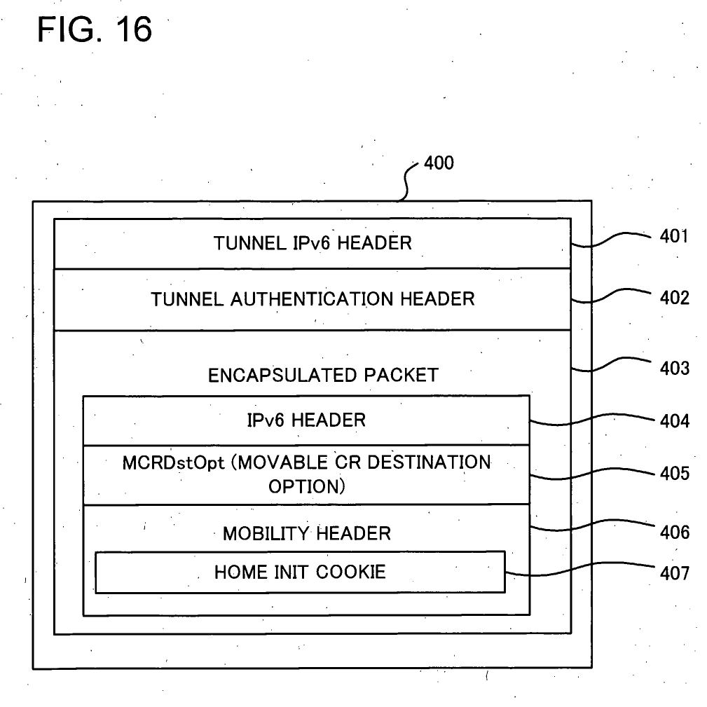

As another preferred method of the present invention, a HoTI message may be used as the test message. FIG. 16 shows a HoTI message, which functions as the test message 403. In this HoTI message, HoA of the initiator node of the test message must be the source address of IPv6 header 404. Therefore, this test message must be encapsulated to tunnel, and the tunnel packet is turned to a packet 400.

In the tunnel packet 400, which has the tunnel IPv6 header 401, CoA of the initiator node is set up as the source address. Because this tunnel packet 400 is a tunnel to HA of the initiator node, the tunnel header has a tunnel authentication header (tunnel AH) 402. This test message is a mobility message. According to the Non-Patent Document 1, tunnel home address destination option is not inserted into the destination extension header.

In case the HoTI message is used as the test message, HoA is used as the source address, and there is no need to insert HoA in MCRDstOpt. Actual content of the option may be empty, or a cryptographic key may be inserted as option. Depending on the type of option, it must be made apparent which type of option it is. The receiver identifies the method to acquire the related information from this message. On the other hand, similarly to a normal HoTI message; a HoTI message comprises a mobility extension header (mobility header) 406, and a home init cookie 407 is present in this message.

The advantage to use this mobility extension header 406 is that there is no need to transmit HoA by MCRDstOpt, and that a cryptographic key can be transmitted by using MCRDstOpt instead. Further, because it is tunneled to HA of the initiator node, the message is turned to a state where higher security is assured. The advantage to use the cryptographic key is that the transmission source of the response message can transmit this key at the time of response, and that the initiator node can have positive proof that the test message has been transmitted to a correct place.

However, when it is necessary to adequately use this solution method under CN environment of nest structure, it is desirable to use HoA of the initiator node in MCRDstOpt of the HoTI message. In so doing, MR can avoid the processing load to check the details up to HoTI packet inside.

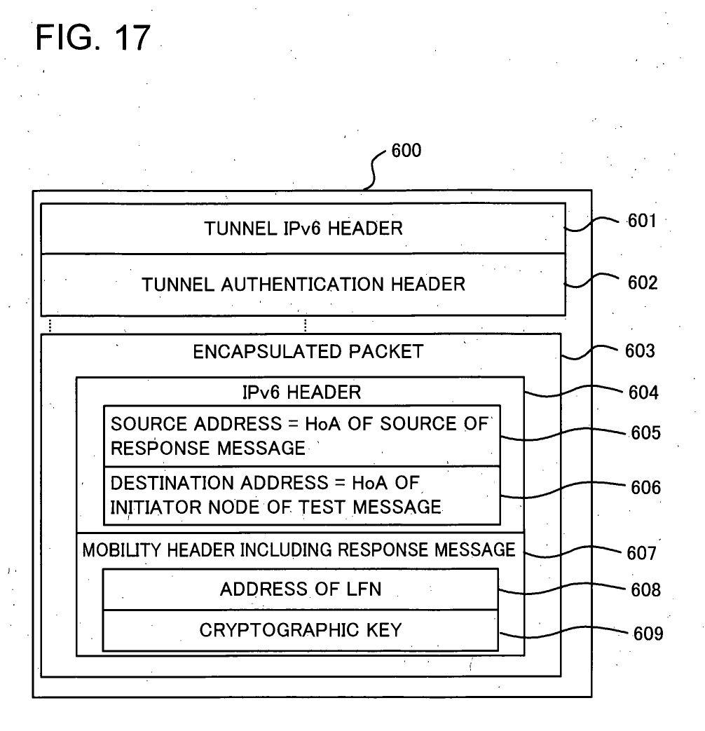

FIG. 17 shows an example of the response message in a preferred embodiment of the present invention. In the embodiment as described above, description has been given on a method where the response message has many parameters including the parameters relating to RR for the purpose of optimizing the signaling. Here, basic structure of the response message is made apparent.

It is considered that the destination address of the response message is HoA of the initiator node of the test message. Also, the source address of the response message is HoA of the initiator of the response message, or in another method, HoA of the node acquiring MCRDstOpt is inserted. The source address and the destination address of the response message 603 are stored in an IPv6 header 604. The IPv6 header 604 has a source address field 605 and a destination address field of the response message. In the source address field 605, HoA of transmission source of the response message is included, for instance, and HoA of the initiator node of the test message is included in the destination address field 606.

Also, the response message can also be arranged as a several new types of mobility extension headers. For the response message, MR gives response as a proxy, and the response message has the address 608 of LFN, to which the test message is addressed. In case a cryptographic key is transmitted by the test message, the cryptographic key 609 may be transmitted so that the receiver of the response message can check the validity of the message. It is desirable that a cryptographic key transmitted by the test message is used as the cryptographic key 609 and that a result of application of cryptographic function is used in the response message. As a result, the receiver can verify the authenticity of the response message.

Also, HoA of the initiator node of the response message is used as the source address similarly to the normal case, and this response message is encapsulated in the tunnel. When the encapsulated response packet 600 is prepared, a tunnel AH 602 is used as the tunnel header together with the tunnel IPv6 header 601.

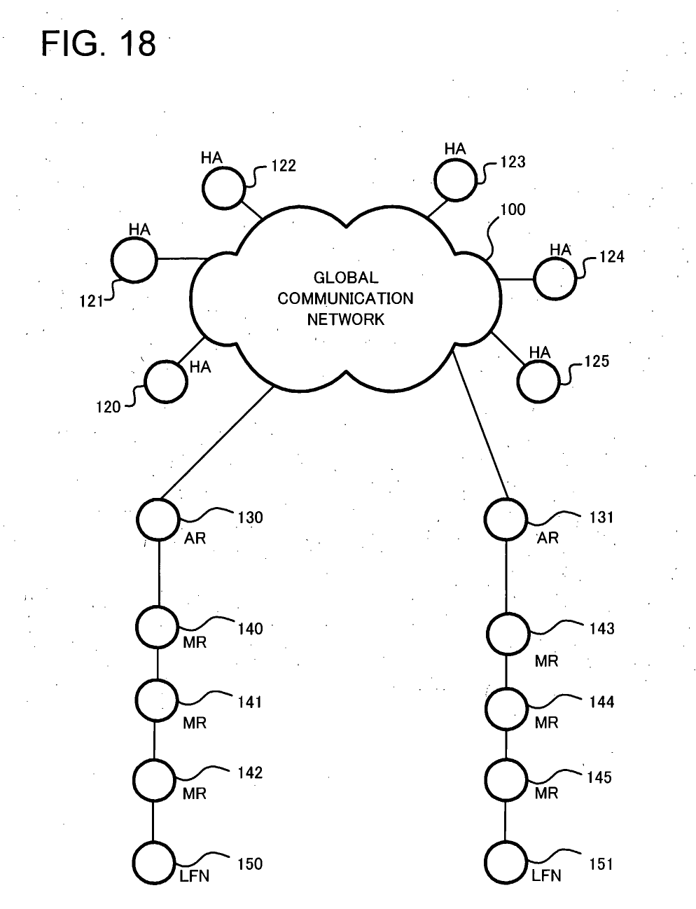

FIG. 18 shows a scenario, in which LFN 150 and LFN 151 trying to perform communication with each other are present in the visited domain and the nest is in three stages. LFN 150 is in nest condition under MR 140, MR 141 and MR 142. HA 120, HA 121 and HA 122 are home agents of MR 140, MR 141 and MR 142 respectively. LFN 151 is in nest condition under MR 143, MR 144 and MR 145. HA 123, HA 124 and HA 125 are home agents of MR 143, MR 144 and MR 145 respectively.

According to the present invention, optimization can also be provided even under such conditions. In this embodiment, it is shown that further execution of the optimization is desirable to reduce the load to signaling when the present invention is carried out under such conditions. Description will be given below on a method to achieve the optimization according to the present invention and it is explained that further extension is needed in order to accomplish the better optimization.

When LFN 150 initiates data communication processing with LFN 151, MR 142 starts the movable CR-RO module, and a test message having MCRDstOpt is transmitted to LFN 151. After passing through HA 120, HA 121 and HA 122, this test message is sent to HA 125. Because HA 125 is a tunnel entry point, MCRDstOpt is copied to the tunnel header. The same processing is performed when the test packet reaches HA 124, and finally, it reaches HA 123. In the last, the test packet reaches MR 143 after being processed by multiple encapsulation.

In case the test packet is transmitted, all of the upstream routers (MR 143, MR 144, MR 145) give attention on a value of MCRDstOpt in addition to the destination address of the inner packet. Then, MR 143, MR 144 and MR 145 transmit response messages respectively to MR 142, i.e. the transmitter of the test message. After the receipt of the responses, MR 142 starts bidirectional RR, BU and BA with each of MR 143, MR 144 and MR 145. After the establishment of these three bidirectional tunnels has been completed, MR 142 initiates data communication optimized by inserting CoA of each of MR 143, 144 and MR 145 to RH2 of the tunnel to MR 145 on the data packet to be transmitted to LFN 151 from LFN 150.

After MR 142 starts the optimized data communication with MR 145, MR 141 starts the test message to MR 143 in order to perform RO. This processing has been already described, and it is performed by starting from the fact that the destination address to be referred by MR 141 is CoA of MR 143. In this way, all of the upstream MRs (MR 140 and MR 141) of MR 142 establish bidirectional tunnel with MR 143 respectively. Therefore, all of the upstream MRs (MR 140 and MR 141) can perform tunneling to MR 143 instead of performing tunneling to own HA.

From the description as given above, it is evident that a multiple of signalings must be carried out in order to solve the problem relating to RO of CN under nest condition. It would be obvious to those skilled in the art that binding storm is accompanied when performing RO. MR 142 must identify CoA of each of MR 143, MR 144 and MR 145 without carrying out a multiple of signalings by optimal and secure method. MR 145 must identify CoA of each of MR 142, MR 141, and MR 140 by the optimal and secure method. Consequently, it is desirable to attain the above purpose when the present invention is extended.

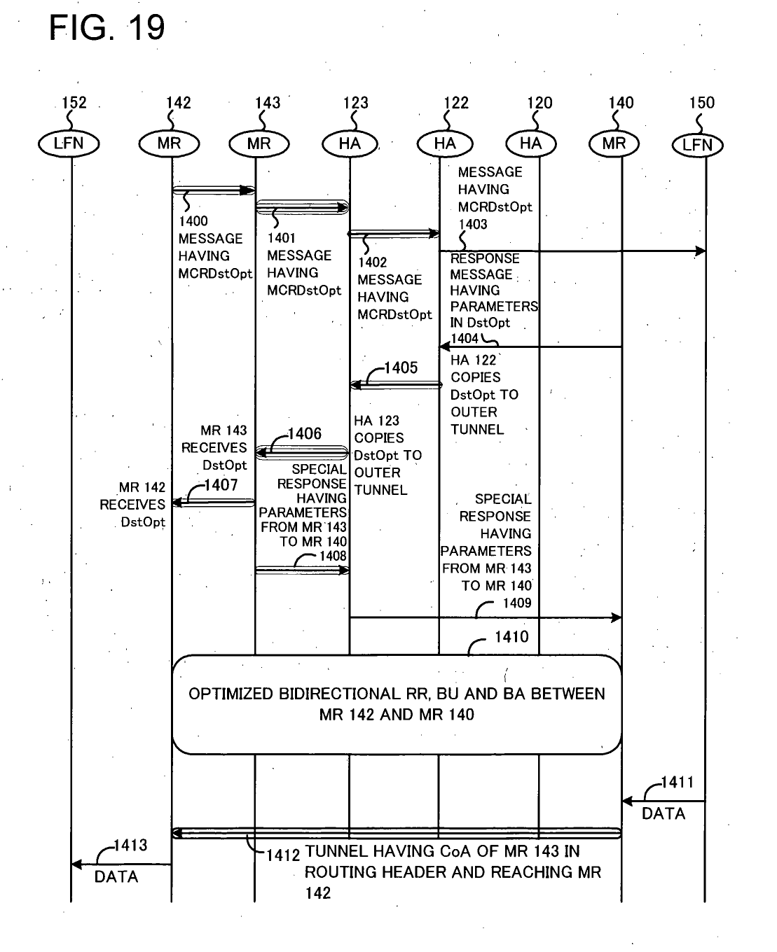

Next, referring to FIG. 19 to FIG. 26, description will be given on another embodiment of the present invention. In this embodiment, description is given on a solution method to solve the problem relating to a scenario with defects (a scenario, in which the present invention does not succeed perfectly), and, in said scenario, attention is focused on the embodiment as described above.

In an embodiment as shown in detail in FIG. 19, a method is described, in which LFN 152 under deep nest condition within the visited domain actualizes a path processed by route optimization (route optimization path (RO path)) through a reduced signaling between LFN 152 and a correspondent node LFN 150, which is connected to MR 140 present on a home link. Referring to FIG. 19, description will be given below on this embodiment.

This route optimization path is transmissively acquired by LFN, which is a peer node. LFN 152 is connected to MR 142. Further, MR 142 is connected to MR 143. MR 142 and MR 143 are connected to the visited link, and HA of MR 142 and HA of MR 143 are HA 122 and HA 123 respectively.

On the other hand, LFN 150 is connected to MR 140, and MR 140 is present on its own home link. One of the home agents of MR 140 present on the home link is HA 120.

In FIG. 19, MR 142 transmits a test message 1400 to a destination, with which LFN 152 is performing communication. In this case, MR 142 adds MCRDstOpt to a header of this message. MCRDstOpt has HoA of MR 142 and two attributes of identifier. Hereinafter, the identifier, i.e. one of the attributes of MCRDstOpt, is called ID (an ID to identify the procedure to establish the tunnel).

Similarly to the above embodiment, this test message 1400 may be HoTI. Therefore, it can be encapsulated by the tunnel to HA 122. The encapsulated test message 1400 is encapsulated by the tunnel to HA 123 at MR 143. A part of the twice-encapsulated message 1401 is decapsulated at HA 123, and an encapsulated message 1402 is transmitted to HA 122. At HA 122, the test message is completely decapsulated, and a message (a message with MCRDstOpt) 1403 reaches LFN 150.

According to the present invention, MR inspects all destination options (also including options, each of which does not have itself as the destination) when it is present on the home link. MR has no need to perform decapsulation processing at home. The complicated processing due to the supervision and the time required for the processing generally does not mean high cost to MR. Thus, these features do not increase the processing load of MR.

In many cases, LFN 150 does not support the route optimization processing. In such case, the message 1403 is often neglected at LFN 150. MR 140 checks MCRDstOpt, and after confirming that a prefix of destination address of the test message 1403 is the prefix possessed by itself, a response message 1404 is transmitted to transmission source of the test message, or this test message is simply transferred, and the response message is not generated.

According to the present invention, MR on the tree path to the destination (MR 142) of the response message is discovered/specified. When generating the response message 1404, MR 140 inserts its own HoA and ID received in the test message into a new destination option, which is called RESDstOpt (ResponseDstOpt; In FIG. 19, it is simply described as DstOpt). This response message has a mobility header where parameters relating to RR are inserted in order to optimize the tunnel-establishing procedure. The response message has further an address of LFN 150.

This message 1404 reaches HA 122. Here, HA 122 encapsulates the message 1404 by the tunnel to MR 142. Further, HA 122 is a tunnel entry point and performs scrutiny on RESDstOpt according to the specification of tunneling. HA 122 understands this option and identifies that the option of this type has only two parameters. Then, HA 122 merely copies the option (RESDstOpt) to the generated tunnel header (the outer tunnel).

The message 1405 reaches HA 123. At HA 123, it is further tunneled to MR 143. Here, HA 123 copies RESDstOpt to a tunnel header generated by HA 123 (the outer tunnel). The twice-encapsulated message 1406 reaches RESDstOpt, and it is decapsulated at MR 143. At the decapsulation, MR 143 acquires a response destination option. Also, MR 143 focuses attention on destination address after the decapsulation.

In this case, the destination address, on which MR 143 focused attention after the decapsulation, is CoA of MR 142. After decapsulation, a message 1407 encapsulated once reaches MR 142. MR 142 is a receiver as desired of the response message. It acquires parameters from RESDstOpt and further acquires parameters from the mobility header. MR 142 checks values of LFN 150 and ID and confirms that a correct response has been received. In this case, it is possible to design in such manner that MR 142 can discriminate LFN/LMN from VMN by using a certain mechanism. Ideally, MR 142 must transmit the test message only to LFN/LMN. VMN can transmit a test message of its own.

Also, MR 142 holds a media access control (MAC) identifier and can identify a response message to the test message transmitted by it. When MR 142 receives a response to the test message, which it did not transmit, it can identify from which of VMN or MR the response message has come by specifying one-hop downstream address from the response message.

According to the present invention, MR 143 identifies the received response message and transmits another response message 1408 to clearly indicate ID received from MR 140 to MR 140. This message 1408 is tunneled to HA 123. At HA 123, a message 1409 is transferred. The parameter as alluded here is not a destination option, and it is transmitted by the mobility header. This is because there is no need to identify the upstream MR on a tree path to the destination by a response-response message (a response message to the response). Finally, this message 1409 reaches MR 140. MR 140 confirms ID and grasps the tree path, for which tracing has been desired, and the parameter is acquired from the message 1409.

Immediately after receiving the response from MR 140, MR 142 starts RR (i.e. optimization RR with MR 140) as explained in the above embodiment. By a stream 1410 of a secure tunnel establishment signaling, MR 140 grasps CoA of MR 142. Then, it is possible to estimate a tree path to reach MR 142 by using a response message obtained from MR 143. MR 143 clearly indicates CoA of MR 142 by the response message. Further, MR 140 acquires CoA of MR 142 from the signaling relating to RR and estimates the tree path to MR 142. According to the present invention, immediately after estimating the tree path, MR 140 can reduce the route of signaling by utilizing the results of estimation of the tree path to the signaling relating to RR.

After RR and the establishment of the tunnel, MR 142 possesses only HoA of MR 140, and it does not possess the tree path to MR 140. Because CoA is not clearly indicated from the response received from MR 140, MR 142 can promptly predict the tree path from the response received from MR 140. Further, MR 142 receives a response from a desired receiver (MR 140) as a first response including the same ID, and it grasps that MR 140 is present on the home. After the establishment of the tunnel with MR 142, MR 140 has a tree path, in which CoA of MR 143, CoA of MR 142, and HoA of MR 142 are tunnel routes. When LFN 150 transmits a data packet 1411 to LFN 152, MR 140 checks whether or not the data packet 1411 has a prefix, which is the same as that of the destination in the new BCE. If the prefix is the same, MR 140 further checks whether a tree path relating to it can be found or not. If it is found, MR 140 sets CoA of MR 143 as a first destination and performs the tunneling to MR 142. A packet 1412 thus tunneled reaches MR 142. After the decapsulation by MR 142, a data packet 1413 is transmitted to LFN 152.

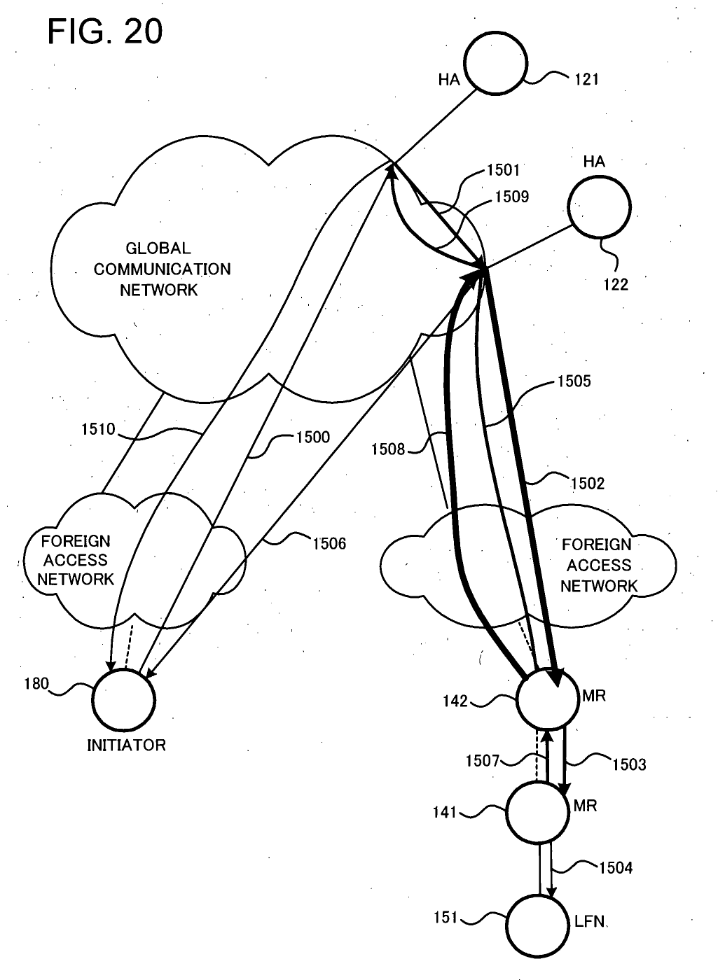

FIG. 20 shows a method to use the present invention for the purpose of attaining the route optimization by reducing RR and BU signaling in a scenario, in which both ends of uni-cast communication are present in the visited domain and one of them is under nest condition.

In FIG. 20, an initiator node (initiator) 180 is connected to a visited link (foreign access network). Also, LFN 151 is connected to MR 141, and further, MR 141 is connected to MR 142. Both MR 141 and MR 142 are present on the visited link, and HA of MR 141 and HA of MR 143 are HA 121 and HA 122 respectively.

The initiator 180 transmits a test message, and this message reaches LFN 151. The routes taken by this message are: Routes 1500, 1501 (tunnel), 1502 (double tunnel), 1503 (a single tunnel after decapsulation), and 1504. Then, it reaches LFN 151. MR 142 and MR 141 receive MCRDstOpt from the received tunnel header and transmits a related response (the same response as the one alluded in another embodiment described above as explained in connection with FIG. 19). MR 141 understands that it is present on the visited link. The only difference is that it inserts CoA of its own into the mobility header of the response message.

In this case, according to the present invention, when HA performs tunneling and copies the attributes of MCRDstOpt to the tunnel header generated by it, HA generates a new attribute called “count attribute” to MCRDstOpt (in case this attribute is not present). According to the scenario shown in FIG. 20, HA 121 sets a value 1 by generating the count attribute. Using this count attribute as the attribute of MCRDstOpt, it is inserted into the tunnel header generated by it. When further encapsulation is carried out at HA 122, the value of this count attribute is incremented to 2 by HA 122. Then, HA 122 sets a value 2 to the count attribute of MCRDstOpt of the tunnel header generated by HA 122.

Upon acquisition of MCRDstOpt, MR 142 receives the count value 2, and MR 141 receives the count value 1. Because MR 142 receives the count value 2, it understands that MR 142 is an upstream MR of the desired receiver and that it is not the receiver as aimed by the test message. As a result, when MR 142 prepares the response message, it inserts parameters such as CoA of its own, ID, and 1-hop address, etc. into the mobility header, and not into the destination option. This is carried out because MR 142 has no need to have upstream MR on the tree path to the destination (the initiator node 180) in order to transmit the response message.

On the other hand, the present invention has the purpose to reduce unnecessary signaling. MR 141 is a desired receiver and it is necessary to find the upstream router on the tree path to the transmitter (the initiator 180) of the test message. Thus, in the response message to be transmitted by MR 141, HoA and ID are included in the destination option.

The routes of the response message of MR 142 are: Routes 1505 (a single tunnel) and 1506 (without tunnel). Also, the routes of the response message of MR 141 are: Routes 1507 (a single tunnel), 1508 (a double tunnel), 1509 (a single tunnel), and finally, 1510 (without tunnel).

From this figure, compared with the response message of MR 141, it is evident that the response message from MR 142 first reaches the initiator 180. Key parameters obtained from the first response are: ID, HoA of MR 142, CoA of MR 142, and CoA of MR 141 (which is obtained when the first test message with MCRDstOpt is decapsulated). On the other hand, parameters of the second response message (response message from MR 141) are: ID, HoA of MR 141, CoA of MR 141, and address of LFN 151.

Upon acquisition of the first response, the initiator 180 recognizes that this response is not from the desired receiver because the value of LFN 151 is not present. Also, the initiator 180 understands from ID that either one of MRs is present on the tree path upstream of LFN 151. By analyzing two response parameters, the initiator 180 can estimate CoA of MR 142, CoA of MR 141, HoA of MR 141, and address of LFN 151 as the tree path because ID is the same and it is the desired response. Therefore, according to the present invention, these results are used when establishing bidirectional tunnel to MR 141 after estimating the tree path from the responses (a plurality of responses from different MRs to a single test message).

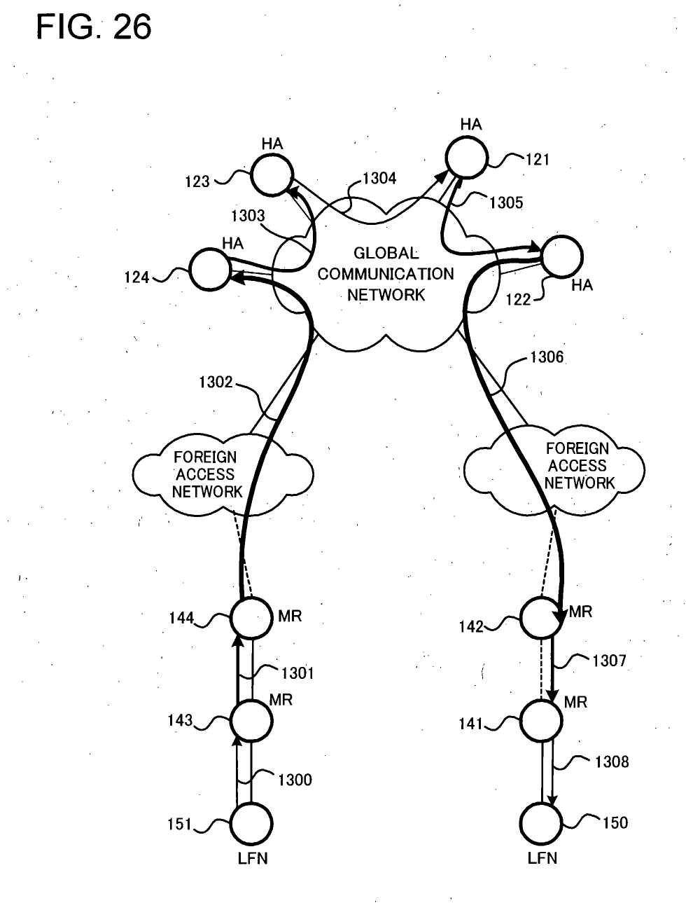

Also, this tunnel is used when data is transmitted to LFN 151. At the tunnel header, the destination address is turned to CoA of MR 142, and CoA of MR 141 and HoA of MR 141 are included in RH2. When the route optimization path is compared with that of the prior art as shown in FIG. 26, the advantages of this mechanism are clearly indicated. The optimized route is formed without using a multiple of RR and BU signaling, and the only necessary and indispensable RR and BU are conducted between the initiator and the desired receiver. After acquiring the related MCR destination option, MR can specify LFN and VMN/MR directly connected by referring to the count attribute and the destination address.

As described above, after acquiring the related MCRDstOpt, MR can specify LFN and VMN/MR directly connected by referring to the count attribute or to the destination address. For example, MR 142 understands that CoA of MR 141 belongs to either VMN or MR and does not belong to LFN because it receives the count value 2. In this case, MR 142 should not start the test message processing to CoA of MR 141.

According to the solution method explained in connection with FIG. 19 and FIG. 20, it is possible to estimate the tree path procedure in simpler manner by using ID, while the status management algorithm in the node to search the tree path may become more complicated. Also, the transmission of ID must be carried out in almost all of the streams of tunnel establishment, and this mechanism may be disadvantageous in some cases because the band is wasted uselessly. Further, until the complete route is estimated, the processing may become more complicated because the node must hold the parameters relating to ID. Also, the complexity of the processing may increase because the value of ID must be checked when the response is received. This means that the status management may be more complicated when ID is used.

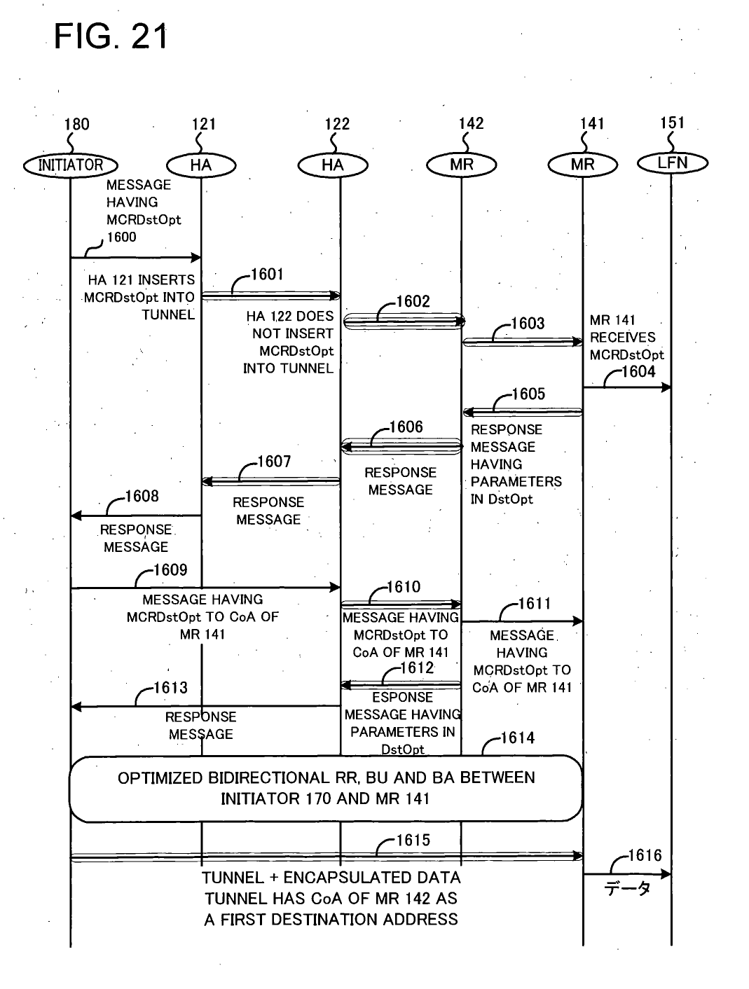

As explained in connection with FIG. 21 and as described in the embodiment of the present invention, there is another method to acquire the tree path of the destination without using ID or the complicated status management algorithm according to the present invention. In this method, a slight delay may occur when finding the tree path of the destination, and signaling may be increased a little. This is different from the method explained in connection with FIG. 20 (a plurality of responses are developed to a single test message). A single response is generated to a single test message. As a result, a plurality of test messages and the same number of responses are generated when searching the tree path.

In FIG. 21, the initiator 180 is present on the visited link. Also, MR 142 and MR 141 are present in the visited domain, and LFN 151 is in nest condition under MR 142 and MR 141. Also, HA 121 is HA of MR 141, and HA 122 is HA of MR 142.

The initiator 180 transmits a test message 1600 containing MCRDstOpt (here, CoTI is used to add MCRDstOpt, for instance). The initiator 180 classifies MCRDstOpt to a copy 1 type and sets an adequate type value (copy flag) to identify the type. The message 1600 reaches HA 121. HA 121 copies MCRDstOpt to the tunnel header generated by it and transmits a message 1601, in which option type of MCRDstOpt in the tunnel header is set to the copy 0 type. The copy 1 type indicates that this option can be copied once to the tunnel header and the copy 0 type means that all tunnel entry points must copy this option to the tunnel header generated at each point.

HA 122 receives the encapsulated message 1601 and tunnels the packet further. However, in accordance with MCRDstOpt of the copy 0 type included in the message 1601, HA 122 does not copy the destination option to the tunnel header. This packet 1602 reaches MR 142. However, MR 142 does not acquire the related parameters because MCRDstOpt is not present in the tunnel header. It simply performs decapsulation, and the packet 1603 is sent to MR 141. MR 141 acquires MCRDstOpt of the copy 0 type. As a result, MR 141 receives only HoA of the initiator 180 (ID is not transmitted by the initiator 180).

Here, MR 141 transmits a normal response message 1605 as indicated in another embodiment explained in connection with FIG. 21. This response message 1605 is transmitted via HA 122 and HA 121 as response messages 1606 and 1607 respectively, and a response message 1608 finally reaches the initiator 180.

The initiator 180 acquires CoA of MR 141 from parameters in the response message 1608. Then, the initiator 180 attempts to search any upstream MR as desired on a route to LFN 151. For this reason, the initiator 180 transmits another text message 1609 to CoA of MR 141. As a result, MR 142 acquires MCRDstOpt of the copy 0 type, which has received a packet 1611, and gives responses as indicated in packets 1612 and 1613. When the response is received, the initiator 180 starts the processing relating to another test message to CoA of MR 142 (not shown in FIG. 21). Then, because the initiator 180 cannot receive the response within a certain fixed time-out period, a tree path can be estimated, along which it is possible to reach LFN 151. Specifically, the initiator 180 acquires parameters such as HoA of MR 141, CoA of MR 141, and address of LFN 151 from the first response. Also, from the second response, the initiator 180 acquires parameters such as HoA of MR 142, CoA of MR 142, CoA of MR 141, etc. Thus, the initiator 180 can estimate the tree path.

After estimating the tree path, the initiator 180 and MR 141 mutually establish bidirectional tunnel. In this case, a signaling stream 1614 is used. Also, information on the tree path is used in the processing to establish the tunnel. After the establishment of the tunnel with MR 141, the initiator 180 has CoA of MR 142, CoA of MR 141, HoA of MR 141, and address of LFN 151 within BCE. The tunneled data message 1615 reaches MR 141. MR performs decapsulation and transmits a data message 1616 to LFN 151. In this scenario, CoA of MR 142 is turned to the destination address of the tunnel.

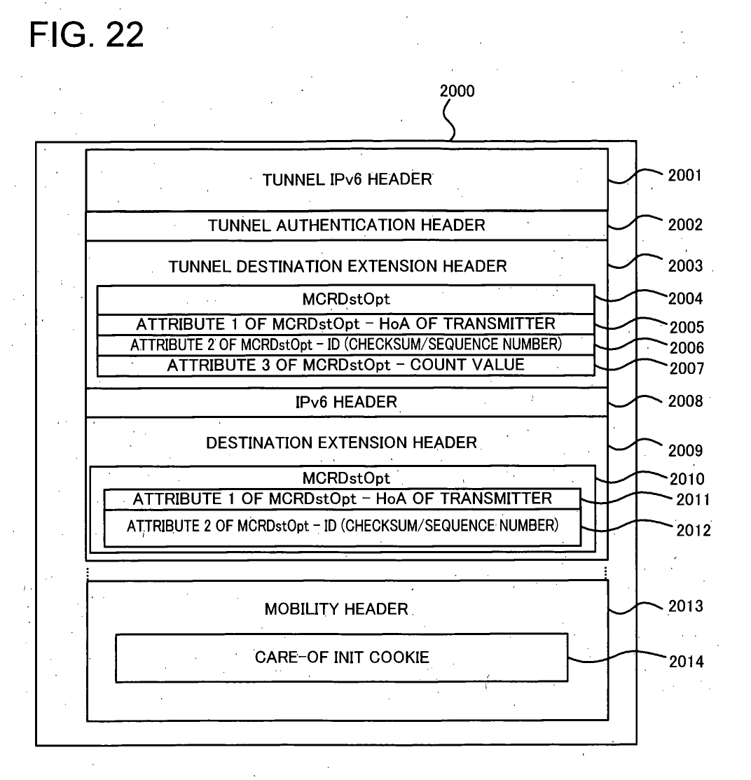

FIG. 22 shows a structure of the packet of the test message after the encapsulation by a first tunnel entry point when a method using ID is applied. The packet 2000 shows a packet of the encapsulated test message.

The packet of the test message is encapsulated, and the packet of the test message has an IPv6 header 2008, a destination extension header 2009, and MCRDstOpt 2010. This MCRDstOpt 2010 has two attributes, i.e. “attribute 1 (2011): HoA of transmitter of the test message 2011” and “attribute 2 (2012): ID”. As ID of the attribute 2 (2012), sequence number, random number, checksum, etc. may be used, for instance.

In case of the sequence number, it is easy to generate ID, while there are security risks because it can be referred and an attacker can start the attack by predicting the sequence. In case of the random number, security risk is lower, but the random number must be generated for each message. In case the checksum is used, hash algorithm must be used for the generation of ID. In this checksum method, it is difficult to carry out replay attack, and it is also difficult for the attacker to predict ID. Therefore, according to the checksum method, higher security can be provided.

Because this is a message based on CoTI, a mobility header 2013 of the test message has a care-of init cookie 2014. Also, the tunnel header has a tunnel IPv6 header 2001, a tunnel AH (authentication header) 2002, and a tunnel destination extension header 2003. The tunnel extension header 2003 has MCRDstOpt 2004. Further, MCRDstOpt 2004 of the tunnel has three attributes, i.e. HoA of the transmitter (2005: the same as 2011), ID (the same as 2006 and 2012), and a count value (2007). Because the tunnel entry point cannot refer to internal MCRDstOpt, this count value is generated.

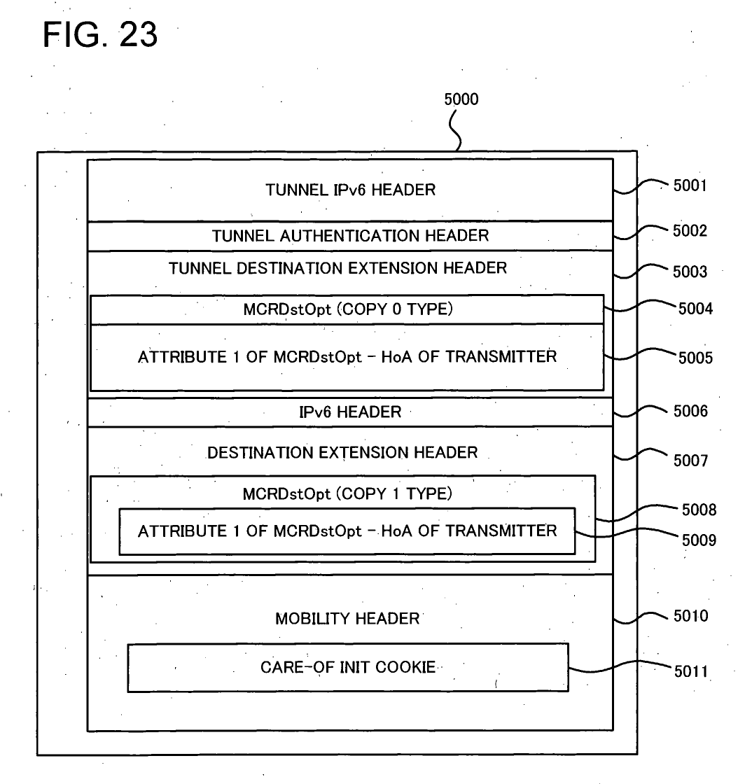

FIG. 23 shows a structure of the packet of the test message after the tunneling at a first tunnel entry point when a mechanism not using ID is applied. In FIG. 23, a copy 1 type is described in MCRDstOpt 5008 of the original test packet. Therefore, the first tunnel entry point to receive this packet copies the content of MCRDstOpt 5008 to a tunnel header generated by itself and describes the copy 0 type to MCRDstOpt in the tunnel header. As a result, all other tunnel entry points do not copy this option when the tunneling is carried out. The attribute value in MCRDstOpt 5004 of the tunnel is the same as the internal original MCRDstOpt 5008.

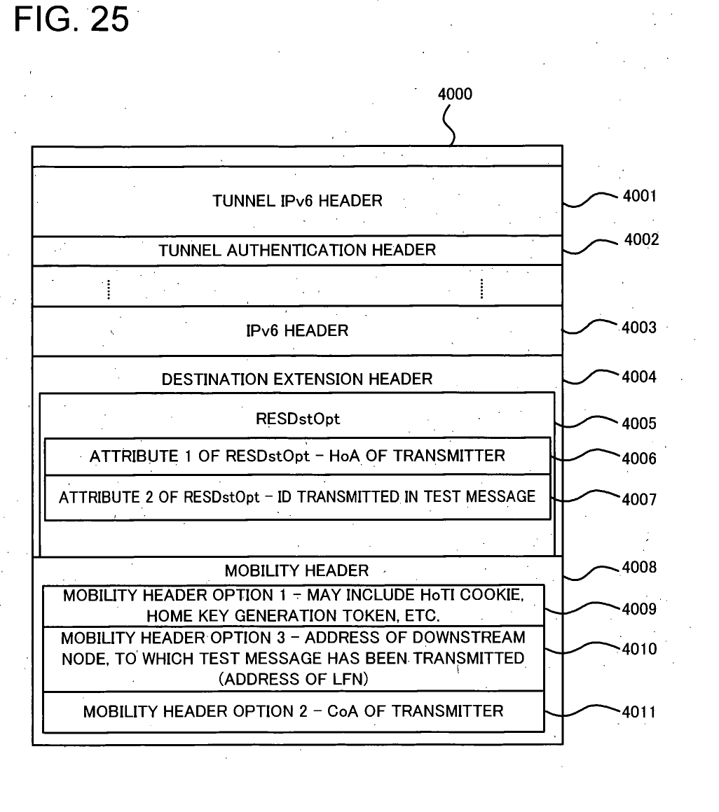

FIG. 25 shows a response packet 4000 to the first test packet from the receiver as desired. In FIG. 25, HoA of the transmitter of the response is used as a source address (as explained in another embodiment described above) in the response message, and it often has a structure as shown in FIG. 25. The transmitter of the response encapsulates the message by tunneling to its own HA. Tunnel field is a tunnel IPv6 header 4001 and a tunnel authentication header (tunnel AH) 4002, and actual response message has an IPv6 header 4003 and a destination extension header 4004. Several response parameters are included in the destination extension header 4004. One of the attributes in the destination extension header 4004 is HoA of the transmitter of the response (attribute 1) 4006. The other attribute is ID (attribute 2) 4007 transmitted in the test message.

The response message 4000 has a mobility header 4008. In the mobility header 4008 of this type, three options are added. The option 4009 indicates option values necessary for execution of RR or for optimization RR such as the home init cookie (HoTI cookie) or a home key generation token. The option 4010 indicates the address of LFN, to which the test message has been transmitted first. Also, the option 4011 indicates CoA of a mobile node to generate the response (i.e. the transmitter).

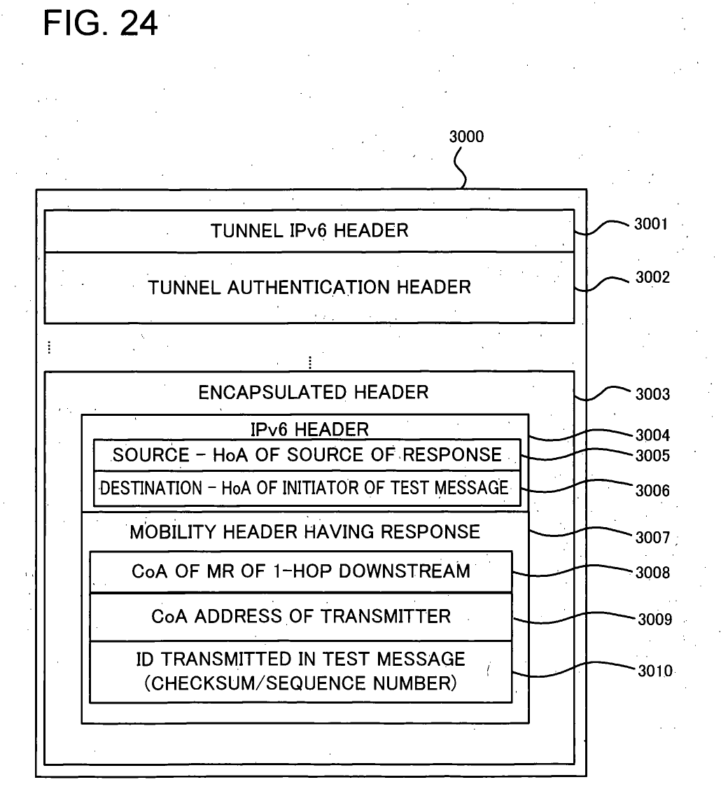

Further, FIG. 24 shows a response message generated by the receiver of MCRDstOpt, which is an upstream MR of an ideal and desired MR as set up to the destination of the test message. In this upstream MR, there is no need to give further response as explained in another embodiment described above. Thus, there is no need to enter the parameters into the destination option (RESDstOpt) as shown in FIG. 25. Therefore, this upstream MR inserts all parameters to the mobility header 3007 as the option. Also, HoA is set up as the source address for this response. Therefore, this response must be tunneled to own HA. The mobility header 3007 has an option 3008. To the option 3008, CoA of 1-hop downstream MR is set up. To the option 3009, CoA of the transmitter (the upstream MR) is set up. To the option 3010, an ID transmitted in the test message is set up.

In the above, the present invention has been disclosed and described in the embodiments, which are considered as the most practical and preferable. However, it would be obvious to those skilled in the art that various changes and modifications may be made on design matters and on the details of the parameters without departing from the spirit and the scope of the present invention.

The functional blocks used in the description of the embodiments of the present invention can be accomplished as LSI (large scale integration), which is a typical example of integrated circuit. The integrated circuits may be used individually as a single chip or may be turned to a single chip so that a part or all can be included. Although it is described as LSI, it may be called IC (integrated circuit), system LSI, super LSI or ultra LSI, depending on the degree of integration.

The technique of integration is not limited to LSI, and it may be designed by using special-purpose circuit or general-purpose processor. After the manufacture of LSI, FPGA (Field Programmable Gate Array), which can be programmed after the manufacture of LSI, or reconfigurable processor, in which connection and setting of circuit cells inside LSI can be reconfigured, may be used.

Further, with the progress of semiconductor technique and of different types of technique derived from it, if a new technique on the integration of circuit may emerge to replace LSI, functional blocks may be integrated by using such technique. For example, one of such possibilities lies in the adaptation of biotechnology.

### INDUSTRIAL APPLICABILITY

The present invention has the effects that the route of data communication can be optimized when two end nodes each being separated away from home perform data communication. This technique can be applied to communication technique using the Internet protocol. In particular, it can be used in the technique relating to the route optimization as defined in the Mobile IPv6.

1. A communication route optimization method for optimizing communication route to be performed between a first communication node and a second communication node under the control of a mobile router, wherein said method comprises the steps of:
inserting a predetermined destination option including information used for optimization of said communication route into a header of a packet to be transmitted to said second communication node;
receiving said packet transmitted to said second communication node from said first communication node by a home agent of said mobile router; and
encapsulating said packet in order to perform tunneling of said packet to said mobile router by the home agent of said mobile router, and inserting said predetermined destination option to the tunnel packet header by copying said predetermined destination option.

2. The communication route optimization method according to claim 1, wherein said method further comprises the steps of:
detecting said packet where said predetermined destination option is present in said tunnel packet header by said mobile router;
transmitting a response message where information to perform route optimization between said first communication node and said mobile router is included by said mobile router to said first communication node;
performing route optimization between said first communication node and said mobile router; and
transmitting a packet to be transmitted between said first communication node and said mobile router so that the packet passes through the route optimized route as a result of said route optimization by said first communication node or said mobile router.

3. The communication route optimization method according to claim 1, wherein said first communication node is a mobile router different from said mobile router, and when a third communication node performing communication with said second communication node is detected, route optimization is performed between said mobile router for the purpose of optimizing the communication route between said second communication node and said third communication node.

4. The communication route optimization method according to claim 1, wherein said first communication node uses a packet relating to a message to perform route optimization between said first communication node and said second communication node as said packet, to which said predetermined destination option is to be inserted.

5. The communication route optimization method according to claim 4, wherein said method comprises a step of transmitting, by said mobile router to said first communication node, a response message including an information to perform route optimization between said first communication node and said mobile router to said message to perform route optimization between said second communication and said mobile router.

6. The communication route optimization method according to claim 1, wherein said first communication node is a mobile node separated away from own home, and own home address is inserted into said predetermined destination option, and own care-of address is set to the source address of the packet where said predetermined destination option is inserted.

7. The communication route optimization method according to claim 1, wherein said first communication node is a mobile node separated away from own home, a cryptographic key is inserted into said predetermined destination option, and own home address is set to a source address of the packet where said predetermined destination option is inserted.

8. The communication route optimization method according to claim 1, wherein said method further comprises the steps of:
detecting the packet where said predetermined destination option is present in said tunnel packet header by said mobile router;
generating an information by said mobile router for verification by using said cryptographic key; and
transmitting a response message where an information for route optimization and said information for verification between said first communication node and said mobile router, by said mobile router to said first communication node.

9. The communication route optimization method according to claim 2, wherein said method comprises the steps of:
checking a predetermined destination option of a packet coming from outside of a mobile network under own control when said mobile router is connected to a home link; and
transmitting said response message by said mobile router when a prefix of the destination address of said packet occurs with a prefix under control of said mobile router.

10. The communication route optimization method according to claim 1, wherein, said method comprises the steps of:
transmitting a response message to said first communication node when all mobile routers transferring said packet transfer said packet including said predetermined destination option; and
estimating, by the first communication node, a route to said second communication node based on said response message from each mobile router.

11. The communication route optimization method according to claim 1, wherein said method comprises the steps of:
inserting an information to indicate that said predetermined destination option can be copied once to a header of said packet by said first communication node;
encapsulating said packet to tunnel to any mobile router as desired by a home agent of said any mobile router, which first received said packet, inserting said predetermined destination to a tunnel packet header by copying said predetermined destination option, and inserting an information to indicate that copying of said predetermined destination option to said tunnel packet header is prohibited; and
transmitting a response message where an information to perform route optimization between said first communication node and said mobile router is included, said message being transmitted to said first communication node by said mobile router to transfer said packet with said header where an information to indicate that said predetermined destination option can be copied once after decapsulation.

12. A communication route optimization control device to be packaged on a mobile node, wherein it is so arranged that own home address or a predetermined destination option including a cryptographic key is inserted to a header of a packet relating to a message to perform route optimization on a route between a correspondent node and said mobile node.

13. A communication route optimization control device to be packaged on a mobile router, wherein communication between a communication node connected under own control and a correspondent node as desired is detected, and it is so arranged that a packet relating to a message to perform route optimization with said any correspondent as desired, and said packet being a packet where own home address or a predetermined destination option including a cryptographic key is inserted is transmitted to said correspondent node as desired.

14. A communication route optimization control device to be packaged on a home agent of a mobile router, wherein it is so arranged that, in case a predetermined destination option including information to be used for route optimization is inserted in a header of a packet to be tunneled to said mobile router, said packet is encapsulated to perform tunneling to said mobile router and said predetermined destination option is inserted into the tunnel packet header by copying said predetermined destination option to the tunnel packet header.

15. A communication route optimization control device to be packaged on a mobile router, wherein it is so arranged that, in case a predetermined destination option including information to be used for route optimization is inserted in a tunnel packet header of an encapsulated packet to be transferred to a communication node control, a response packet including own home address and the address of the communication node under control is transmitted.

16. A communication route optimization control device packaged on a mobile router, wherein said device checks a predetermined destination option included in a packet coming from outside of a mobile network under own control when the device is connected to a home link, and said device transmits said response message when a prefix of an address included in said predetermined destination option of said packet concurs with a prefix under control of said mobile router.

17. A communication router optimization control device to be packaged on a mobile node, wherein said device transmits a packet with a predetermined destination option inserted therein to any correspondent node as desired, and said device estimates a route to said second communication node by receiving a response message to said packet from a mobile router to pass through before the arrival of said packet at said any communication node as desired.

18. A communication route optimization control device to be packaged on a mobile router, wherein said device transmits a response message to a transmission source of said packet when said packet including a predetermined destination option is transferred.

19. A communication route optimization control device to be packaged on a mobile node, wherein said device transmits a packet to any correspondent node as desired by adding an information to a packet where a predetermined destination option is inserted, said information is to indicate that said predetermined destination option can be copied only once to an encapsulated header when said packet is encapsulated.

20. A communication route optimization control device to be packaged on a home agent of a mobile router, wherein said device copies said predetermined destination option to an encapsulated header at the encapsulation of said packet when a packet including an information to indicate that said predetermined destination option can be copied only once together with the predetermined destination option, and said device is designed to add an information to indicate that copying of said predetermined destination option of said encapsulated header is prohibited.
